(19) United States
(12) Patent Application Publication
(10) Pub. No.: US 2026/0012260 A1
(43) Pub. Date: Jan. 8, 2026

(54) OPTICAL REPEATER, OPTICAL NETWORK SYSTEM, AND OPTICAL REPEATING METHOD

(71) Applicant: NEC Corporation, Tokyo (JP)

(72) Inventors: Shoma TATENO, Tokyo (JP); Hidemi NOGUCHI, Tokyo (JP)

(73) Assignee: NEC Corporation, Tokyo (JP)

(21) Appl. No.: 19/241,575

(22) Filed: Jun. 18, 2025

(30) Foreign Application Priority Data
Jul. 2, 2024 (JP) 2024-107023

(51) Int. Cl. H04B 10/291; H04B 10/532; H04B 10/61

(52) U.S. Cl. CPC H04B 10/291; H04B 10/532; H04B 10/6151

(57) ABSTRACT

An optical repeater monitors a rotation angle from a reference angle of polarization indicated by a plurality of signal channels included in an optical signal, and uses a control value that controls the rotation angle from the reference angle of polarization of any of the plurality of signal channels to align the rotation angle from a reference angle of polarization of each signal channel to a rotation angle that improves the reception characteristics of each signal channel.

This application is based upon and claims the benefit of priority from Japanese patent application No. 2024-107023, filed on Jul. 2, 2024, the disclosure of which is incorporated herein in its entirety by reference.

### TECHNICAL FIELD

The present disclosure relates to an optical repeater, an optical network system, and an optical repeating method.

### BACKGROUND ART

In recent years, 5G wireless communication systems have been introduced, and in the post-5G era, there is a growing demand for high-capacity communication, ultra-high speed, ultra-low latency, and many simultaneous connections, not only in wireless communication but also in the field of optical communication. For this reason, research is being conducted on optical communication systems with the expectation that they will be used for various communication services and industrial applications.

For example, in backbone optical communication systems, digital coherent systems combining optical phase modulation systems and polarization multiplexing and separation technologies are used to achieve capacities in excess of 100 Gbps. In addition, research and development of transmission systems that improve frequency utilization efficiency and enable multiple simultaneous connections by narrowing the signal bandwidth and using wavelength division multiplexing (WDM) is also underway. Research and development are also being conducted on distortion compensation technology that uses optical or digital signal processing to compensate for signal distortion that occurs during optical transmission, such distortion hindering high-capacity communications due to high baud rates and high multi-level signal modulation in optical communication systems.

As a related technique, for example, Japanese Unexamined Patent Application Publication No. 2011-146795 (Patent Document 1) is known. Paragraph 0045 of Patent Document 1 discloses that an optical transmission system is provided with an optical fiber transmission line, an optical repeater, a polarization tracking device, and an optical receiver, and moreover is provided with a transmission line polarization detection device that detects the polarization of an optical signal or a quantity that depends on it, a polarization management device that observes the polarization variation of the optical signal input to the optical receiver from the detected amount from the transmission channel polarization detection device and controls the output polarization of the polarization multiplex transmitter described above to eliminate this polarization variation, and a system management device that transmits the amount of polarization variation detected by the transmission line polarization detection device to the polarization management device.

In the technology related to the optical network system described above, it is required to suppress deterioration of signal quality in optical transmission.

An example object of the present disclosure is to provide an optical repeater, an optical network system, an optical repeating method, and a program that solve the above-mentioned problems.

### SUMMARY

An optical repeater according to one example embodiment of the present disclosure includes a monitor means that monitors a rotation angle from a reference angle of polarization indicated by a plurality of signal channels included in an optical signal, and a calculation means that uses a control value that controls the rotation angle from the reference angle of polarization of any of the plurality of signal channels to align the rotation angle from a reference angle of polarization of each signal channel to a rotation angle that improves the reception characteristics of each signal channel.

An optical network system according to one example embodiment of the present disclosure includes an optical repeater and a control device, wherein the optical repeater includes a monitor means that monitors a rotation angle from a reference angle of polarization indicated by a plurality of signal channels included in an optical signal, and a calculation means that uses a control value that controls the rotation angle from the reference angle of polarization of any of the plurality of signal channels to align the rotation angle from a reference angle of polarization of each signal channel to a rotation angle that improves the reception characteristics of each signal channel, and the control device includes a management means that calculates the control value based on the reception characteristic of the optical signal in a rear-stage device that received the optical signal relayed by the optical repeater, and outputs the control value to the optical repeater.

An optical repeating method according to one example aspect of the present disclosure monitors a rotation angle from a reference angle of polarization indicated by a plurality of signal channels included in an optical signal, and uses a control value that controls the rotation angle from the reference angle of polarization of any of the plurality of signal channels to align the rotation angle from a reference angle of polarization of each signal channel to a rotation angle that improves the reception characteristics of each signal channel.

A non-transitory storage medium storing a program according to one example aspect of the present disclosure causes a computer of an optical repeater to function as a monitor means that monitors a rotation angle from a reference angle of polarization indicated by a plurality of signal channels included in an optical signal, and a calculation means that uses a control value that controls the rotation angle from the reference angle of polarization of any of the plurality of signal channels to align the rotation angle from a reference angle of polarization of each signal channel to a rotation angle that improves the reception characteristics of each signal channel.

### BRIEF DESCRIPTION OF THE DRAWINGS

FIG. 1 is a diagram showing a configuration example of an optical network system according to a basic example.

FIG. 2 is a configuration diagram showing a configuration example of an optical repeater according to a basic example.

FIG. 3 is a configuration diagram showing a configuration of the optical transmitter/receiver according to the present disclosure.

FIG. 4A is a diagram for illustrating the challenges of the optical transmitter/receiver according to the present disclosure.

FIG. 4B is a diagram for illustrating the challenges of the optical transmitter/receiver according to the present disclosure.

FIG. 5 is a configuration diagram showing the outline configuration of the control system according to the present disclosure.

FIG. 6 is a configuration diagram showing the outline configuration of the optical repeater according to the present disclosure.

FIG. 7 is a configuration diagram showing an example configuration of an optical network system according to one example embodiment of this disclosure.

FIG. 8 is a configuration showing a configuration example of each device in an optical network system according to one example embodiment of the present disclosure.

FIG. 9A is a conceptual diagram showing a specific example of carrier frequency control by a control method in accordance with one example embodiment of this disclosure.

FIG. 9B is a conceptual diagram showing a specific example of carrier frequency control by a control method in accordance with one example embodiment of this disclosure.

FIG. 9C is a conceptual diagram showing a specific example of carrier frequency control by a control method in accordance with one example embodiment of this disclosure.

FIG. 10 is a configuration showing a configuration example of each device in an optical network system according to one example embodiment of the present disclosure.

FIG. 11 is a configuration diagram showing an example configuration of the chromatic dispersion compensation portion according to one example embodiment of this disclosure.

FIG. 12A is a conceptual diagram that shows a specific example of chromatic dispersion compensation according to one example embodiment of this disclosure.

FIG. 12B is a conceptual diagram that shows a specific example of chromatic dispersion compensation according to one example embodiment of this disclosure.

FIG. 13 is a flowchart showing an example of the operation of an optical network system according to one example embodiment of this disclosure.

FIG. 14A is a diagram that shows a specific example of chromatic dispersion compensation by a control method according to one example embodiment of this disclosure.

FIG. 14B is a diagram that shows a specific example of chromatic dispersion compensation by a control method according to one example embodiment of this disclosure.

FIG. 14C is a diagram that shows an overview of the phase conjugation processing according to one example embodiment of this disclosure.

FIG. 15 is a configuration showing a configuration example of each device in an optical network system according to one example embodiment of the present disclosure.

FIG. 16 is a diagram illustrating another configuration example of each device in the optical network system according to an example embodiment of the present disclosure.

FIG. 17 is a diagram illustrating a change in reception characteristics according to the difference in the rotation angle of polarization of two signal channels included in an optical signal according to an example embodiment of the present disclosure.

FIG. 18 is a diagram showing monitor characteristics of a polarization monitor portion according to an example embodiment of the present disclosure.

FIG. 19 is a diagram showing an overview of a process for matching the rotation angles of each signal channel in a digital signal processing portion according to an example embodiment of the present disclosure.

FIG. 20 is a functional block diagram of an optical repeater according to another example embodiment of the present disclosure.

FIG. 21 is a diagram showing a processing flow of an optical repeater according to another example of an example embodiment of the present disclosure.

FIG. 22 is a configuration diagram showing an overview of the hardware of a computer according to an example embodiment of the present disclosure.

### EXAMPLE EMBODIMENT

Hereinafter, example embodiments of an optical network system, a control method, a control program, a control device, and an optical repeater according to the present disclosure will be described with reference to the drawings. In each drawing, identical elements are denoted by the same reference numerals, and duplicate explanations are omitted where necessary. Note that arrows added to the configuration diagrams (block diagrams) are for illustrative purposes only and do not limit the type or direction of signals.

### (Considerations Leading to Implementation)

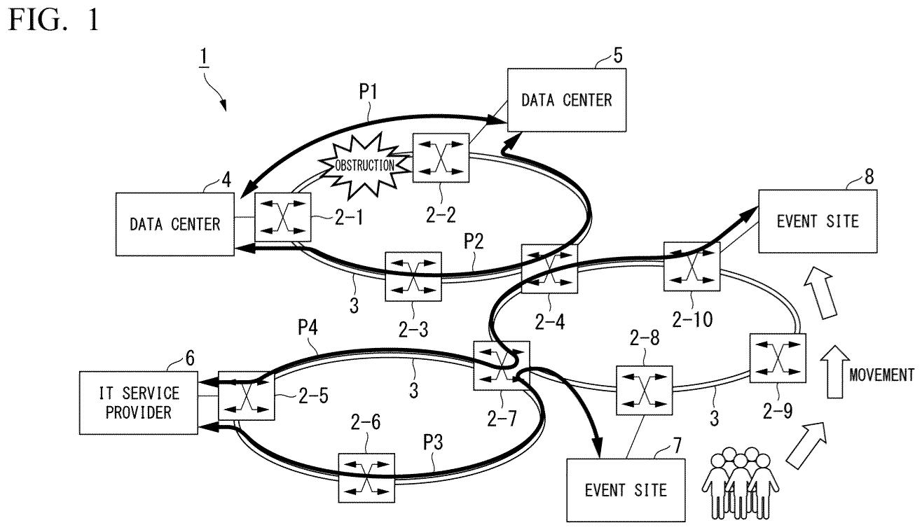

FIG. 1 shows the configuration of an optical network system according to the basic example serving as the basis of the present example embodiment. An optical network system 1 according to the basic example is, for example, a backbone wavelength-division multiplexing optical transmission system, and achieves high-capacity communication of over 100 Gbps by the devices comprising the system performing wavelength multiplexing of optical signals, as well as high-level modulation and digital coherent transmission with optical signals at different wavelengths. High-density wavelength division multiplexing enables improved optical frequency utilization efficiency, allowing the system to handle mobile traffic and wavelength defragmentation.

The optical network system 1 includes optical repeaters 2 (e.g., 2-1 to 2-10) that can flexibly switch transmission lines (wavelength paths or optical transmission lines) while maintaining the optical signals in order to accommodate switching of transmission lines in case of failure or to meet local traffic demand (e.g., traffic demand for communications from networks of data centers 4 and 5, the network of an IT service provider 6, and networks of event venues 7 and 8). The optical network system 1 can maintain communication via optical signals as infrastructure by including the optical repeaters 2 (e.g., 2-1 to 2-10). Each optical repeater 2 is a photonic node that can relay wavelength-multiplexed optical signals and is, for example, a reconfigurable optical add-drop multiplexer (ROADM) device. Each optical repeater 2 is assigned a wavelength path (also referred to simply as a path), and forwards traffic of the local network and other optical repeaters 2 accommodated via optical communication cables that pass optical signals of the assigned wavelength path to the destination network or other communication devices. The optical network system 1 uses optical repeater devices 2-1 and 2-2 to transfer traffic between the data center 4 and the data center 5 via path P1. In a case where an obstacle occurs in the path P1, the optical network system 1 can transfer traffic between the data center 4 and the data center 5 via path P2 using optical repeater devices 2-1, 2-3, and 2-4 instead of optical repeater devices 2-1 and 2-2. Similarly, according to accommodate switching of transmission lines in case of failure or to meet local traffic demand, the optical network system 1 may use one or more optical repeater devices 2 between the IT service provider 6, event venue 7, and event venue 8 to transfer traffic via a path including path P3 or path P4.

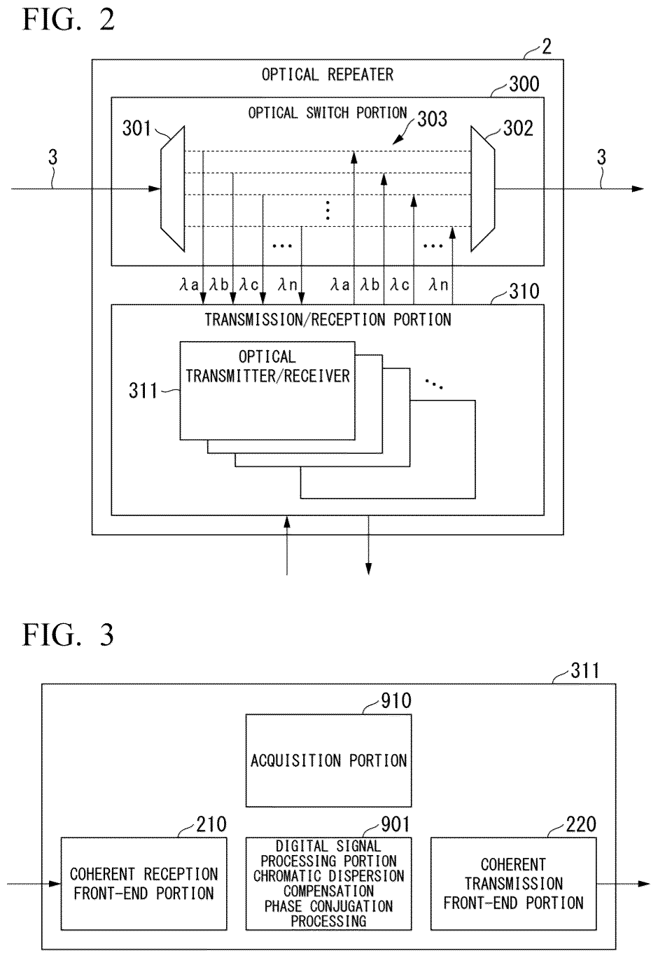

FIG. 2 shows a configuration example of the optical repeater 2 according to a basic example. The optical repeater 2 branches/inserts optical wavelength multiplex signals and coherently modulates and demodulates the signals of each wavelength subject to branching/insertion. As shown in FIG. 2, the optical repeater 2 is provided with an optical switch portion 300 and a transmission/reception portion 310.

The optical switch portion 300 forwards optical signals of a given wavelength path received from the front-stage optical repeater 2 in the optical network system 1 to the rear-stage optical repeater 2, and also branches/inserts the received optical signals by wavelength. For example, the optical switch portion 300 is provided with a demultiplexer 301, a multiplexer 302, and a branching/insertion portion 303. The demultiplexer 301 separates an optical signal received from the optical transmission line 3 into optical signals of multiple wavelengths λₐ, λ_{b}, λ_{c}, . . . , λₙ. The multiplexer 302 combines optical signals of multiple wavelengths λₐ, λ_{b}, λ_{c}, . . . , λₙ into a single optical signal and transmits it to the optical transmission line 3. The branching/insertion portion 303 branches/inserts optical signals of each wavelength between the demultiplexer 301 and the multiplexer 302.

The transmission/reception portion 310 (transponder) receives optical signals of each wavelength branched from the branching/insertion portion 303 of the optical switch portion 300 and outputs coherently demodulated received data to the local device (network) that accommodates it. The transmission/reception portion 310 inputs transmission data from the local device and transmits (inserts) optical signals of each wavelength that have been coherently modulated to the branching/insertion portion 303 of the optical switch portion 300. The transmission/reception portion 310 is equipped with a plurality of optical transmitters/receivers 311 that transmit and receive optical signals at various wavelengths. Each optical transmitter/receiver 311 receives optical signals of a predetermined wavelength and further transmits optical signals of a predetermined wavelength (the same or different wavelength from the received wavelength) to the destination.

The issues that arise in a case where using an optical transmitter/receiver as the optical transmitter/receiver 311 are discussed here. FIG. 3 shows an example configuration of an optical transmitter/receiver according to this disclosure. As shown in FIG. 3, the optical transmitter/receiver 311 according to this disclosure is provided with a coherent reception front-end portion 210, a coherent transmission front-end portion 220, an acquisition portion 910, and a digital signal processing portion 901. Digital signal processing enables phase conjugation processing and chromatic dispersion compensation on a per-channel basis.

The coherent reception front-end portion 210 performs coherent detection of the optical signal received from the optical repeater 2 in the previous stage using local oscillator (LO) light of a predetermined wavelength and outputs the detected signal to the digital signal processing portion 901. The coherent transmission front-end portion 220 optically modulates the signal processed by the digital signal processing portion 901 to a predetermined wavelength (coherent modulation) and transmits the generated optical signal to the optical repeater 2 of the next stage. The digital signal processing portion 901 is a digital signal processing portion (DSP) that converts the signal detected coherently by the coherent reception front-end portion 210 into a digital signal, outputs the processed received data, replays the input transmission data, and outputs the signal converted for optical modulation to the coherent transmission front-end portion 220. In this disclosure, phase conjugation processing and chromatic dispersion compensation are performed on a per-channel basis in the digital signal processing portion 901.

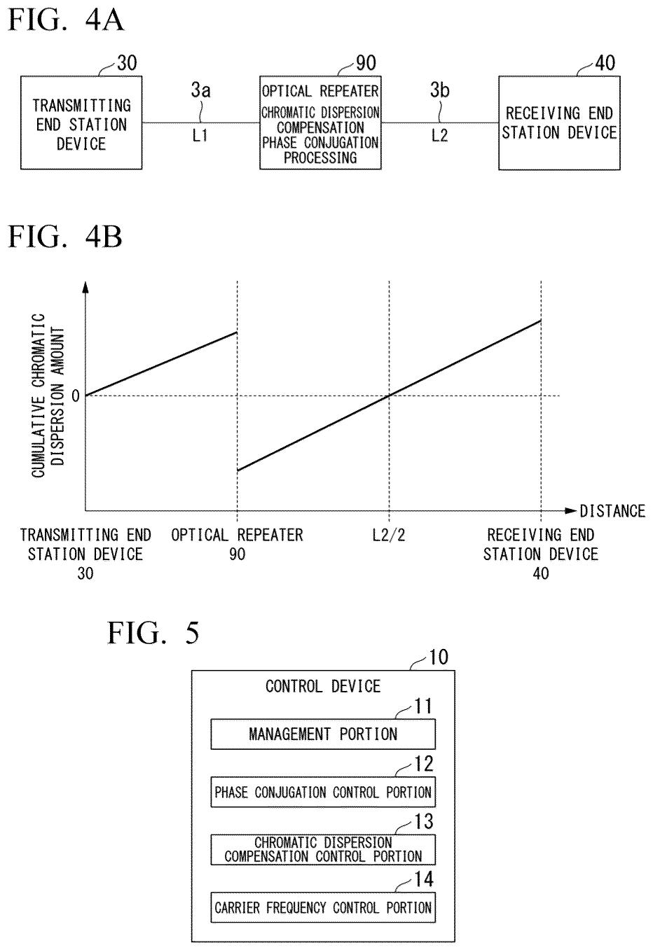

FIG. 4A and FIG. 4B show the chromatic dispersion amount in a case where using an optical repeater 90 including the optical transmitter/receiver 311 of this disclosure. As shown in FIG. 4A, the optical repeater 90 is connected between the transmitting end station device (transmitting end) 30 and the receiving end station device (receiving end) 40 via optical transmission lines 3a and 3b. The optical transmission line 3a consists of distance L1 and optical transmission line 3b consists of distance L2, and L1 and L2 may be the same length or different. Optical signals of wavelength λ1 are transmitted in the optical transmission line 3a, and optical signals of wavelength λ2 are transmitted in the optical transmission line 3b.

In a configuration in which the optical repeater 90 is connected to the path from the transmitting end station device 30 to the receiving end station device 40 as shown in FIG. 4A, the side closer to the transmitting end station device 30 than the optical repeater 90 may be called the first stage of the optical repeater 90 (the reception side of optical signals) while the side closer to the receiving end station device 40 than the optical repeater 90 may be called the second stage of the optical repeater (the transmission side of optical signals). The optical transmission line between the optical repeater 90 and the transmitting end station device 30 may be referred to as the front-stage (first portion) optical transmission line, and the optical transmission line between the optical repeater 90 and the receiving end station device 40 as the rear-stage (second portion) optical transmission line.

As shown in FIG. 4B, the chromatic dispersion amount increases in proportion to the distance of the optical transmission line. Therefore, if the optical repeater 90 relays optical signals only by mere signal amplification, the chromatic dispersion amount continues to increase with distance from the transmitting end station device 30 to the receiving end station device 40. Then, as the distance of the optical transmission line increases, the quality of the optical signal received at the receiving end station device 40 deteriorates significantly. In addition to chromatic dispersion, nonlinear distortion also causes significant degradation of optical signal quality. Nonlinear distortion is a phenomenon in which the phase of light itself changes due to a change in the refractive index in the material in proportion to the optical signal intensity as the optical signal propagates through the optical fiber. Such nonlinear distortion is a limiting factor for high-capacity and long-distance transmission of optical signals due to high baud rate and high multi-level transmission.

In the example disclosed above, in a case where the optical repeater 90 connected to the path from the transmitting end station device 30 to the receiving end station device 40 receives optical signals consisting of one or more optical channels, phase conjugation processing and equivalent digital signal processing of chromatic dispersion compensation are performed for each channel received. In the example disclosed above, in the optical repeater 90, the nonlinear distortion generated in the transmission path of the front stage and the nonlinear distortion generated in the transmission path of the rear stage are canceled by performing phase conjugation processing and chromatic dispersion compensation, whereby the effect of nonlinear distortion at the receiving end station device 40, which is the receiving end, can be mitigated.

The example disclosed above here compensates for the effects of in-channel nonlinear distortion in optical transmission lines. Intra-channel nonlinear distortion refers to the nonlinear distortion that occurs within a single channel during single-channel transmission through the optical transmission line.

In addition to the example disclosed above, it is desirable to be able to obtain sufficient compensation effect for inter-channel nonlinear distortion in a case where there are multiple optical channels of optical transmission signals transmitted in an optical fiber. The present disclosure makes it possible to compensate for nonlinear effects between channels during multi-channel transmission in optical repeaters in multiple optical transmission networks. Nonlinear distortion can be classified into intra-channel nonlinear distortion and inter-channel nonlinear distortion. Intra-channel nonlinear distortion indicates the nonlinear distortion generated in the relevant channel by the optical signal of the channel. On the other hand, inter-channel nonlinear distortion indicates the nonlinear distortion generated within a channel due to the optical signals of channels other than the channel in question in a case where multiple optical channels are transmitted through the optical transmission line.

The following is an overview of the present example embodiment. In a case where an optical repeater receives optical signals consisting of multiple channels, the repeater configuration is shown with optical phase conjugation for compensation of inter-channel nonlinear distortion in addition to intra-channel nonlinear distortion, and optimal chromatic dispersion compensation and carrier frequency switching according to the channel frequency bandwidth. Furthermore, although the effect of compensating for intra-channel nonlinear distortion and inter-channel nonlinear distortion is smaller, either one of optimal chromatic dispersion compensation or carrier frequency switching may be used depending on the channel band.

### (Overview of Example Embodiment)

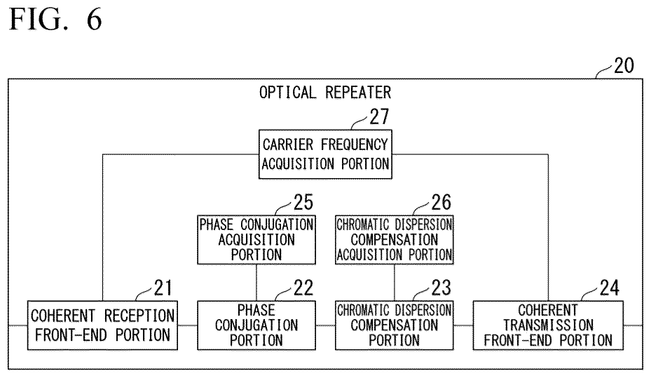

FIG. 5 shows the outline configuration of the control device according to the present example embodiment. FIG. 6 shows the outline configuration of the optical repeater system according to the present example embodiment. A control device 10 and an optical repeater 20 constitute an optical network system. The optical repeater 20 according to the present example embodiment constitutes a part of the optical network system, and the control device 10 according to the present example embodiment controls the optical repeater 20, which is another component of the optical network system.

As shown in FIG. 5, the control device 10 is provided with a management portion 11, a phase conjugation control portion 12, a chromatic dispersion compensation control portion 13, and a carrier frequency control portion 14. The management portion 11 manages transmission line information of optical transmission lines connected to the optical repeater 20 in an optical network path. The phase conjugation control portion 12 determines the phase conjugation process in the optical repeater 20 based on the transmission line information managed by the management portion 11 and the wavelength information managed by the carrier frequency control portion 14. The chromatic dispersion compensation control portion 13 determines the chromatic dispersion compensation amount to be applied in the optical repeater 20 based on the transmission line information managed by the management portion 11 and the carrier frequency managed by the carrier frequency control portion. The carrier frequency control portion 14 specifies the order of magnitude of frequency values in the frequency domain for each channel of an optical signal consisting of multiple channels received by the optical repeater 20, and controls the carrier frequency of the transmitted signal of each channel so that the order of magnitude of frequency values in the frequency domain is switched for each channel in the frequency domain in the transmitted signal.

As shown in FIG. 6, the optical repeater 20 is provided with a coherent reception front-end portion 21, a phase conjugation portion 22, a chromatic dispersion compensation portion 23, a coherent transmission front-end portion 24, a phase conjugation acquisition portion 25, a chromatic dispersion compensation acquisition portion 26, and a carrier frequency acquisition portion 27. Although not shown in FIG. 6, multiple optical channels are transmitted and received, and phase conjugation, chromatic dispersion compensation, and carrier frequency setting are performed for each channel signal.

The phase conjugation acquisition portion 25 acquires the phase conjugation process determined by the phase conjugation control portion 12 from the control device 10. The chromatic dispersion compensation acquisition portion 26 acquires the chromatic dispersion compensation amount determined by the chromatic dispersion compensation control portion 13 from the control device 10. The carrier frequency acquisition portion 27 acquires information on the reception carrier frequency and transmission carrier frequency of each channel as determined by the carrier frequency control portion 14. The coherent reception front-end portion 21 performs coherent detection of the received optical signal based on the local oscillator light of the reception carrier frequency obtained from the carrier frequency acquisition portion 27 and outputs a coherently detected electrical signal. The phase conjugation portion 22 performs phase conjugation processing by digital signal processing on the electrical signal output from the coherent reception front-end portion 21 based on the phase conjugation processing settings acquired by the phase conjugation acquisition portion 25. The chromatic dispersion compensation portion 23 performs chromatic dispersion compensation processing by digital signal processing on the electrical signal output from the phase conjugation portion 22 based on the chromatic dispersion compensation amount acquired by the chromatic dispersion compensation acquisition portion 26. The coherent transmission front-end portion 24 performs coherent modulation on the electrical signal subject to phase conjugation processing by the phase conjugation portion 22 and the electrical signal subject to chromatic dispersion compensation processing by the chromatic dispersion compensation portion 23 based on the local oscillator light of the transmission carrier frequency acquired from the carrier frequency acquisition portion 27, and transmits the coherently modulated optical signal.

Thus, in the present example embodiment, the control device 10 determines the phase conjugation processing and the chromatic dispersion compensation amount in the optical repeater 20 based on the wavelength information and the signal bandwidth information of optical signals transmitted and received by the optical repeater 20 in the path, and the transmission line information of the optical transmission line connected to the optical repeater 20. The control device 10 performs the determined phase conjugation processing and chromatic dispersion compensation of the chromatic dispersion compensation amount for compensation of nonlinear distortion in the optical repeater 20. The control device 10 specifies the order of magnitude of frequency values in the frequency domain for each channel of an optical signal consisting of multiple channels received by the optical repeater 20, and compensates for inter-channel nonlinear effects by controlling the carrier frequency so that the order of magnitude of frequency values in the frequency domain is switched for each channel in the frequency domain in the transmitted signal.

By performing phase conjugation of optical signals with the optical repeater 20, it is possible to invert the distortion of the optical signal in the front-stage optical transmission line of the optical repeater 20. As the signal propagates through the rear-stage optical transmission path of the optical repeater 20, the distortion is reproduced in reverse and so the distortion is canceled at the receiving end. Since the example embodiment described below enables chromatic dispersion compensation with appropriate phase conjugation and a chromatic dispersion compensation amount in the optical repeater 20, using the phase conjugation and chromatic dispersion compensation at each optical repeater 20 in a multi-span optical network, it is possible to maximize the cancellation effect of nonlinear distortion caused by multi-span optical transmission, enabling the effective suppression of degradation of signal quality due to nonlinear distortion at the receiving end of the optical network. Additionally, by selecting the optimal chromatic dispersion compensation according to the carrier frequency and signal bandwidth, and the carrier frequency so as to switch the order of magnitude of frequency values in the frequency domain for each channel in a multi-channel optical signal in the optical repeater 20, it is also possible to suppress inter-channel nonlinear effects.

### Example Embodiment 1

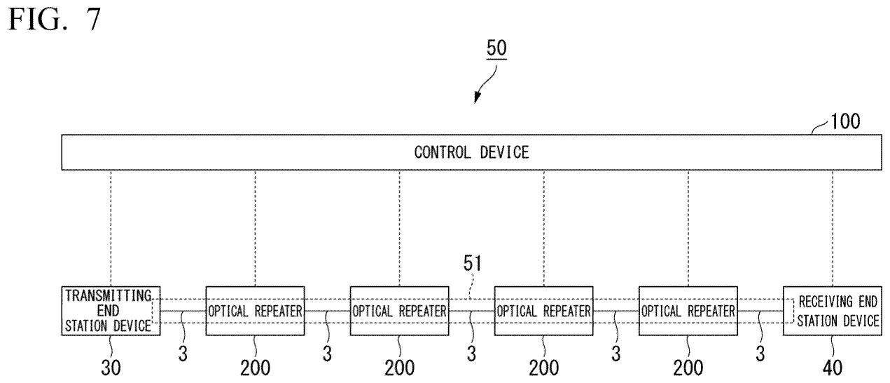

Next, Example Embodiment 1 shall be explained with reference to the drawings. FIG. 7 shows a configuration example of an optical network system in accordance with one example embodiment of the present disclosure. As shown in FIG. 7, an optical network system 50 in accordance with one example embodiment of the present disclosure is provided with a control device 100, a plurality of optical repeaters 200, the transmitting end station device 30, and the receiving end station device 40.

The plurality of the optical repeaters 200, the transmitting end station device 30, and the receiving end station device 40 are connected to each other via optical transmission lines 3 to enable optical communication. The plurality of the optical repeaters 200, the transmitting end station device 30, the receiving end station device 40, and the control device 100 are connected to enable communication of control signals. The plurality of the optical repeaters 200, the transmitting end station device 30, the receiving end station device 40 and the control device 100 may be connected via the optical transmission lines 3 or may be communicatively connected by any other transmission line, including wired or wireless.

The plurality of the optical repeaters 200, the transmitting end station device 30, and the receiving end station device 40 are optical transmission devices (optical nodes) that perform optical communications via the optical transmission lines 3. The transmitting end station device 30 constitutes the transmitting end in a path configured by the connection of multiple optical transmission paths 3. The receiving end station device 40 constitutes the receiving end in a path configured by the connection of multiple optical transmission lines 3. The transmitting end station device 30 transmits multi-channel optical signals wavelength-multiplexed by the wavelength of the path set by the control device 100 to the receiving end station device 40 via the optical transmission lines 3. The receiving end station device 40 receives the multi-channel optical signals wavelength-multiplexed by the wavelength of the path set by the control device 100 from the transmitting end station device 30 via the optical transmission lines 3.

The plurality of optical repeaters 200 are repeaters that can relay wavelength-multiplexed multi-channel optical signals, as in the basic example. The plurality of optical repeaters 200 constitute an optical network 51 that performs WDM communications. The plurality of the optical repeaters 200, together with the transmitting end station device 30 and the receiving end station device 40, can be said to constitute the optical network 51. The optical network 51 is a wavelength-division multiplexed optical network, as in FIG. 1. The optical network 51 can be a mesh-shaped network, ring-shaped network, point-to-point, or other topology. The plurality of the optical repeaters 200 configure a path from the transmitting end station device 30 to the receiving end station device 40 in accordance with the control from the control device 100, and transmit optical signals (data) according to wavelengths set on the route of the path.

The control device 100 manages and controls the optical network 51 including the plurality of the optical repeaters 200. For example, the control device 100 is a Network Management System (NMS) that manages the network.

The control device 100 manages and controls the paths configured by the optical repeater 200 in the optical network 51. The control device 100 manages the path route and wavelengths from the transmitting end station device 30 to the receiving end station device 40, and sets the path route and wavelengths etc. for the transmitting end station device 30, the receiving end station device 40 and the optical repeaters 200 on the path route.

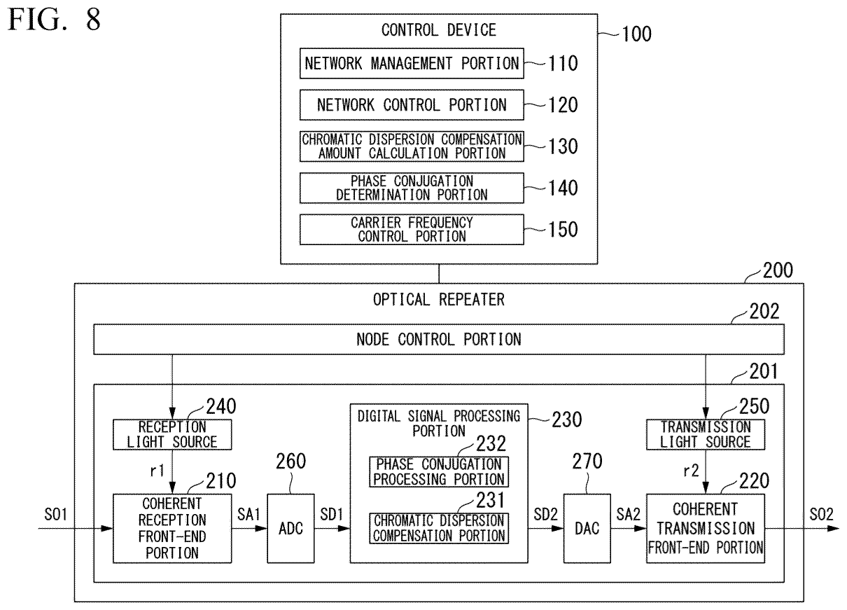

FIG. 8 shows a configuration example of each device in an optical network system according to one example embodiment of the present disclosure. As shown in FIG. 8, the control device 100 is provided with a network management portion 110, a network control portion 120, a chromatic dispersion compensation amount calculation portion 130, a phase conjugation determination portion 140, and a carrier frequency control portion 150.

The network management portion 110 corresponds to the management portion 11 shown in FIG. 5 and manages information necessary for network management, such as network configuration information and path configuration information in the optical network 51. For example, the network management portion 110 may consist of a database that stores information necessary for network management. The network configuration information includes the connection relationship among the optical repeaters 200, transmitting end station device 30, and receiving end station device 40 that comprise the network, as well as transmission line information for the optical transmission lines 3 that connect the devices. Transmission line information includes the distance L (transmission path length) of the optical transmission line and may include the structure and type of optical fibers, transmission characteristics, and the like. The path configuration information includes information on each device comprising the path, the wavelengths available to each device on the route of the path, and the usage status of the wavelengths. These pieces of information may be set in a database in advance, or may be set by information collected from each device, and may also be updated by the network control portion 120 and the like.

The network control portion 120 corresponds to the management portion 11 shown in FIG. 5, and controls the paths in the optical network 51 and the optical repeaters 200, the transmitting end station device 30, and the receiving end station device 40 that comprise the paths. The network control portion 120 refers to the network configuration information, path configuration information, and the like in the network management portion 110, determines the route of the paths from the transmitting end station device 30 to the receiving end station device 40, and sets the determined route to the transmitting end station device 30, receiving end station device 40, and optical repeaters 200 on the route of the paths. The network control portion 120 outputs the information necessary to calculate the chromatic dispersion compensation amount in the optical repeaters 200 that constitute the path to the chromatic dispersion compensation amount calculation portion 130. For example, the network control portion 120 outputs transmission line information for the front and rear optical transmission lines. The network control portion 120 outputs the phase conjugation determination information in the optical repeater 200 that constitutes the path to the phase conjugation determination portion 140. For example, the network control portion 120 outputs the number of paths and the number of optical repeaters in the optical network 51.

The chromatic dispersion compensation amount calculation portion 130 calculates the chromatic dispersion compensation amount for the optical repeaters 200 comprising the path to perform chromatic dispersion compensation, corresponding to the chromatic dispersion compensation control portion 13 shown in FIG. 5. The chromatic dispersion compensation amount calculation portion 130 is a compensation control portion that determines and controls the chromatic dispersion compensation amount of each optical repeater 200. The chromatic dispersion compensation amount calculation portion 130 determines the optimal chromatic dispersion compensation amount for the optical repeater 200 based on the reception wavelength information, signal bandwidth, transmission wavelength information, and transmission line information before and after the optical repeater 200 acquired from the network control portion 120 and the carrier frequency control portion 150. The chromatic dispersion compensation amount calculation portion 130 notifies the relevant optical repeater 200 of the reception wavelength information, transmission wavelength information, and optimal chromatic dispersion compensation amount of the optical repeater 200.

The phase conjugation determination portion 140 controls the phase conjugation processing of the optical repeaters 200 that comprise the path, corresponding to the phase conjugation control portion 12 shown in FIG. 5. The phase conjugation determination portion 140 determines the optimal phase conjugation processing for each optical repeater 200 based on the number of paths and the number of optical repeaters in the optical network 51 acquired from the network control portion 120. The phase conjugation determination portion 140 notifies the optical repeater 200 of the phase conjugation processing information.

The carrier frequency control portion 150, which corresponds to the carrier frequency control portion 14 shown in FIG. 5, determines the carrier frequency of each channel of an optical signal in the path from the transmitting end station device 30 to the receiving end station device 40, and sets the determined carrier frequency to the transmitting end station device 30, the receiving end station device 40 and optical repeaters 2 on the route of the path. The carrier frequency of the light in a path is determined for each optical transmission path in the route of the path. The carrier frequency control portion 150 outputs the information necessary to calculate the chromatic dispersion compensation amount in the optical repeaters 200 that constitute the path to the chromatic dispersion compensation amount calculation portion 130. For example, the carrier frequency control portion 150 outputs the reception wavelength information (wavelength information of received optical signals) and transmission wavelength information (wavelength information of transmitted optical signals) of the optical repeater 200.

Suppose that optical repeater 200 receives an optical signal consisting of multiple channels. The carrier frequency selection portion 150 specifies, among the plurality of channels of different frequency bands of the optical signal received by the relevant optical repeater 200, the order of magnitude of the frequency values of each channel of the plurality of channels ordered based on the frequency band, and determines the carrier frequency of each channel in the received signal so that the order is reversed in the transmission signal, and the carrier frequency of each channel in the transmission signal based on the signal bandwidth. The carrier frequency selection portion 150 notifies the relevant optical repeater 200 of the determined carrier frequency for each channel of the received signal and transmitted signal of the optical repeater 200.

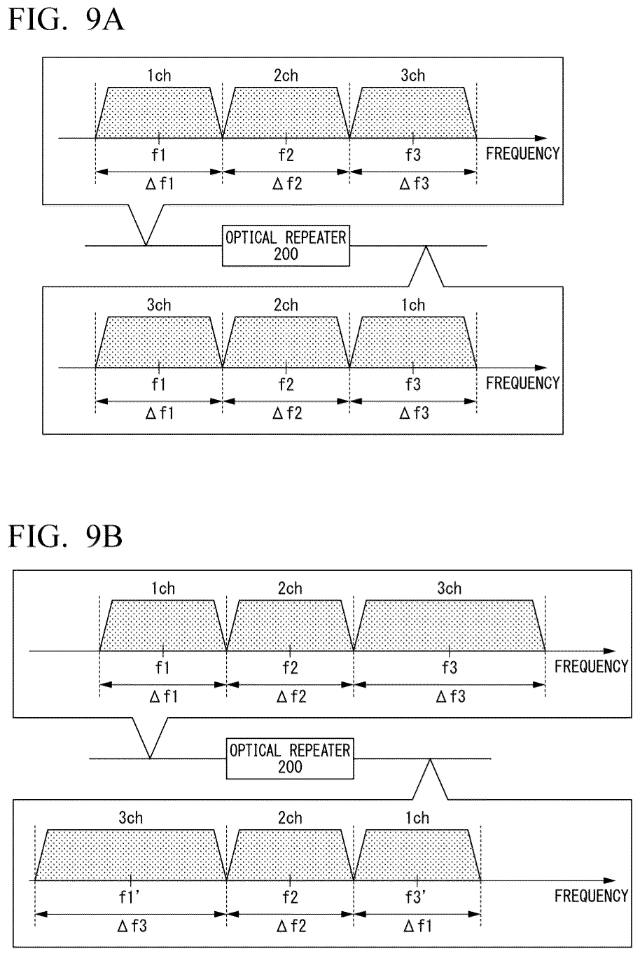

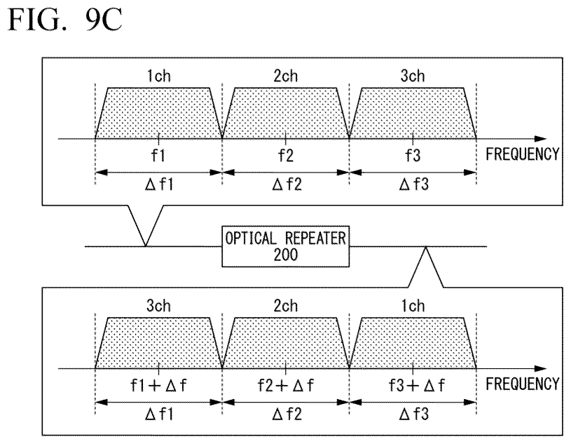

FIG. 9A is the first diagram showing an overview of the carrier frequency settings for performing channel switching as directed by the carrier frequency selection portion 150. The optical repeater 200 is assumed to receive signals in the frequency bands of the first channel 1ch, the second channel 2ch, and the third channel 3ch. The carrier frequencies of each channel are f1, f2, and f3, respectively, and the respective signal bands of the channels are Δf1, Δf2, and Δf3. The carrier frequency control portion 150 sets the carrier frequency of each channel so as to produce an output signal in which the order of magnitude of the frequency values in the frequency domain of the channel received by the optical repeater 200 is reversed. In a case where the signal bandwidths of the channels are all equal, the order of the magnitude of the frequency values of the channels is reversed by setting the carrier frequency of the first channel to f3, the carrier frequency of the second channel to f2, and the carrier frequency of the third channel to f1.

FIG. 9B is the second diagram showing an overview of the carrier frequency settings for performing channel switching as directed by the carrier frequency selection portion 150. The optical repeater 200 is assumed to receive signals in the frequency bands of the first channel 1ch, the second channel 2ch, and the third channel 3ch. The carrier frequencies of each channel are f1, f2, and f3, respectively, and the signal bands are Δf1, Δf2, and Δf3, respectively. Assume that the signal bandwidths indicated by Δf1, Δf2, and Δf3 are not equivalent, respectively. The carrier frequency control portion 150 sets the carrier frequency of each channel so as to produce an output signal in which the order of magnitude of the frequency values in the frequency domain of the channel received by the optical repeater 200 is reversed. The carrier frequencies of each of the first, second, and third channels of the output signal of the optical repeater 200 are f3′ (=f2+(f2−f1)), f2, f1′ (=f2−(f3−f2)), so that the order of magnitude of frequency values of each channel is in reverse order. The optical repeater 200 outputs optical signals with the signal bandwidth of each channel set the same for reception and transmission by the optical repeater 200. In other words, the signal bandwidths during transmission by the optical repeaters 200 of channels 1ch, 2ch, and 3ch are the same Δf1, Δf2, and Δf3 as the signal bandwidths during reception, respectively.

FIG. 9C is a third diagram showing an overview of carrier frequency settings for channel switching as directed by the carrier frequency selection portion 150. Each optical repeater 200 is assumed to receive signals in the frequency bands of the first channel 1ch, the second channel 2ch, and the third channel 3ch. The carrier frequencies of each channel are f1, f2, and f3, respectively, and the signal bands are Δf1, Δf2, and Δf3, respectively. The carrier frequency control portion 150 sets the carrier frequency of each channel so as to produce an output signal in which the order of the magnitude of the frequency values in the frequency domain of each channel received by the optical repeater 200 is reversed, and furthermore, each channel is given a uniform frequency offset Δf. By setting the carrier frequencies of the first, second, and third channels of the output signal of the optical repeater 200 as f3+Δf, f2+Δf, and f1+Δf, the order of the magnitude of the frequency values of each channel is reversed, and an optical signal with uniform frequency offset is also transmitted. This allows the optical repeater 200 to transmit to the path a transmission signal having a bandwidth different from the bandwidth of the optical signal received by the optical repeater 200. It can be applied to wavelength conversion repeater systems that convert the wavelengths of received and transmitted signals in the optical repeater.

In the optical network 51, multi-channel optical signals are relayed by multiple optical repeaters 200 through optical transmission lines 3. In a case where the multiple optical repeaters 200 in the optical network 51 change the channel order for the channels of an optical signal, the carrier frequency at the receiving end of the channels is notified to the receiving end station device 40.

As shown in FIG. 8, the optical repeater 200 according to one example embodiment of the present disclosure is equipped with an optical transmitter/receiver 201 and a node control portion 202. Although the illustration is omitted in FIG. 8, in order to perform transmission and reception of multiple optical channels, the optical repeater 200 includes the optical switch portion 300 and the transmission/reception portion 310, as in the basic example in FIG. 2, and includes a plurality of the optical transmitters/receivers 201 in the transmission/reception portion 310. In other words, the node control portion 202 can control the optical switch portion 300 and the transmission/reception portion 310 (the multiple optical transmitters/receivers 201 (equivalent to the optical transmitter/receiver 311 in FIG. 3)).

Each optical transmitter/receiver 201 is provided with the coherent reception front-end portion 210, the coherent transmission front-end portion 220, a digital signal processing portion 230, a reception light source 240, a transmission light source 250, an analog to digital converter (ADC) 260, and a digital to analog converter (DAC) 270. The number of digital signal processing portions 230 provided may correspond to the number of channels included in the optical signal.

The reception light source 240 generates local oscillator light r1 of the wavelength (frequency) set by the node control portion 202 and outputs the generated local oscillator light r1 to the coherent reception front-end portion 210. The transmission light source 250 generates the transmission light r2 of the wavelength (frequency) set by node control portion 202 and outputs the generated transmission light r2 to the coherent transmission front-end portion 220.

The frequency (wavelength) of the local oscillator light r1 is the frequency (carrier frequency) of the input optical signal SO1 that is received, and the frequency of the transmission light r2 is the frequency of the output optical signal SO2 that is transmitted. The carrier frequencies of local oscillator light r1 and r2 are determined based on the carrier frequency information obtained by the node control portion 202 from the carrier frequency control portion 150.

The coherent reception front-end portion 210 and the coherent transmission front-end portion 220 have the same configuration as in FIG. 3. The coherent reception front-end portion 210 is an optical/electrical converter that converts optical signals to electrical signals and is a coherent detection portion that performs coherent detection. The coherent reception front-end portion 210 performs coherent detection of the input optical signal SO1 (received optical signal) that is input based on the local oscillator light r1, and outputs the generated analog signal SA1 (first analog electrical signal).

The ADC 260 performs analog/digital conversion of the analog signal SA1 generated by the coherent reception front-end portion 210 and outputs the converted digital signal SD1 (first digital electrical signal).

The DAC 270 performs digital/analog conversion of the digital signal SD2 (second digital electrical signal) processed by the digital signal processing portion 230 and outputs the converted analog signal SA2 (second analog electrical signal).

The coherent transmission front-end portion 220 is an electrical/optical converter that converts electrical signals to optical signals and a coherent modulation portion that performs coherent modulation. The coherent transmission front-end portion 220 coherently modulates the analog signal SA2, which has been DA-converted by the DAC 270, based on the transmission light r2, and outputs the generated output optical signal SO2 (transmitted optical signal).

For example, the input optical signal SO1 and the output optical signal SO2 are phase modulated and polarization multiplexed optical signals. The analog signals SA1 and SA2 and digital signals SD1 and SD2 are four-lane (4-channel) signals that include the IX signal of the I component (in-phase component) of X polarization, the QX signal of the Q component (quadrature component) of X polarization, the IY signal of the I component of Y polarization, and the QY signal of the Q component of Y polarization.

The digital signal processing portion 230 performs digital signal processing on the digital signal SD1 converted by the ADC 260 and outputs the digital signal SD2 after digital signal processing. The digital signal processing portion 230 is a digital circuit that performs the prescribed digital signal processing to compensate for signal quality. The digital signal processing portion 230 performs digital signal processing on all or some of the four-lane IX, QX, IY, and QY signals (X or Y polarization), respectively.

The digital signal processing portion 230 performs specific signal processing without performing processing that involves significant delays, such as code error correction (data regeneration). This allows the required signal quality to be compensated while minimizing signal delay. In the present example embodiment, the digital signal processing portion 230 has a chromatic dispersion compensation portion 231 (equivalent to the chromatic dispersion compensation portion 23 in FIG. 6) that performs chromatic dispersion processing and a phase conjugation processing portion 232 (equivalent to the phase conjugation portion 22 in FIG. 6) that performs phase conjugation processing.

The chromatic dispersion compensation through digital signal processing can be realized by convolution of the impulse response of the inverse transfer function of an optical transmission line with the received signal. Thus, for example, the chromatic dispersion compensation portion 231 may be configured with a transversal filter (finite impulse response (FIR) filter). Since the characteristics of optical transmission lines can be modeled by an FIR filter, chromatic dispersion can be compensated by an FIR filter with inverse characteristics. The FIR filter performs Time Domain Equalizing (TDE), which equalizes the received signal in the time-delay domain, while Frequency Domain Equalization (FDE), which equalizes the received signal in the frequency domain, may achieve the same characteristics. By configuring the chromatic dispersion compensation portion with FDE, the circuit scale can be reduced compared to that of an FIR filter.

In addition to transmission line chromatic dispersion compensation, the chromatic dispersion compensation portion 231 may also compensate for bandwidth degradation caused by characteristic degradation and characteristic variation of analog electrical circuits in each of the four lanes of IX, QX, IY, and QY signals, amplitude variation in the four lanes, and skew and cross-talk in the four lanes.

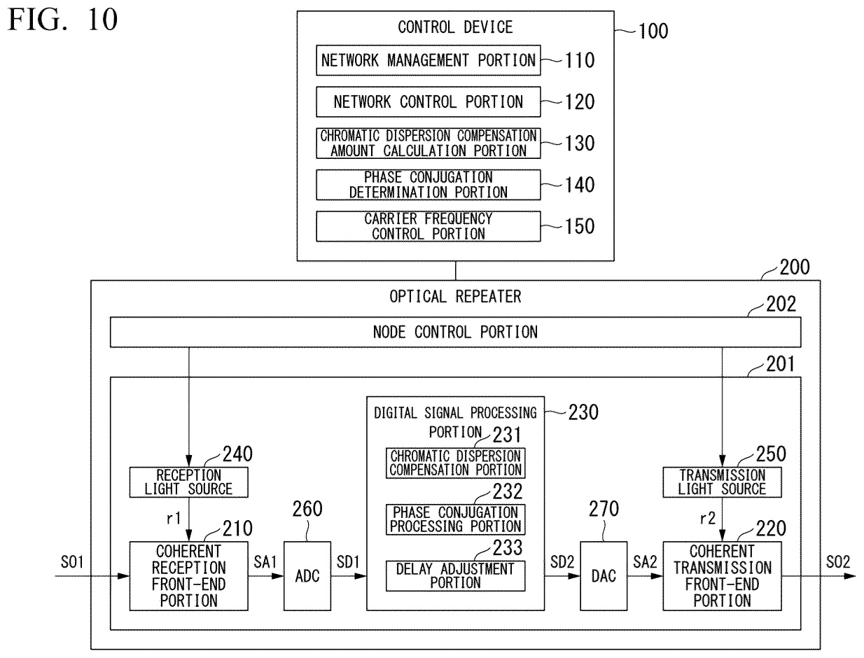

FIG. 10 shows another configuration example of each device in an optical network system according to one example embodiment of the present disclosure. As shown in FIG. 10, the delay adjustment portion 233 of the digital signal processing portion 230 of the optical repeater 200 may provide a delay that compensates for variations in optical path length inside the optical repeater and timing deviations caused by ADC, DCA and digital signal processing in a case where multiple optical signals are transmitted and received.

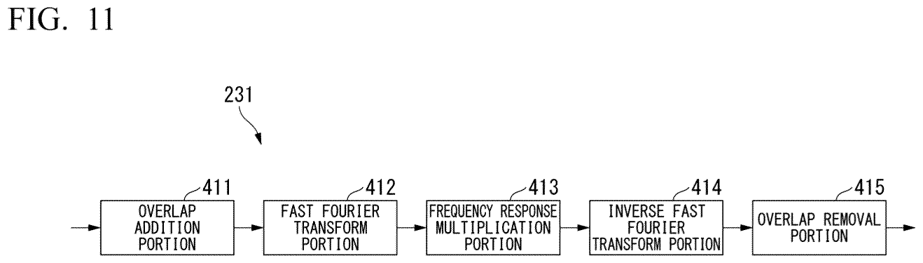

FIG. 11 is a configuration example in a case where the chromatic dispersion compensation portion 231 is configured by FDE processing. The chromatic dispersion compensation portion 231 in FIG. 11 is an example of an overlap FDE configuration and is provided with an overlap addition portion 411, a fast Fourier transform portion 412, a frequency response multiplication portion 413, an inverse fast Fourier transform portion 414, and an overlap removal portion 415.

The node control portion 202 sets the chromatic dispersion compensation amount notified by the control device 100 to the chromatic dispersion compensation portion 231 in the digital signal processing portion 230. In a case where the chromatic dispersion compensation portion 231 is configured with an FDE as shown in FIG. 9, the node control portion 202 sets the coefficient of the frequency response multiplication portion 413 in FIG. 9 according to the chromatic dispersion compensation amount notified by the control device 100 and the carrier frequency and signal bandwidth of each channel.

The overlap addition portion 411 causes a portion of the front and rear signals to overlap the input signal (digital signal). The fast Fourier transform portion 412 then performs a fast Fourier transform (FFT) of the overlapped signal to convert the signal into a frequency domain signal.

The frequency response multiplication portion 413 multiplies and equalizes the frequency response of the chromatic dispersion of the transmission line according to the chromatic dispersion compensation amount notified by the control device 100 and the carrier frequency and signal band of each channel.

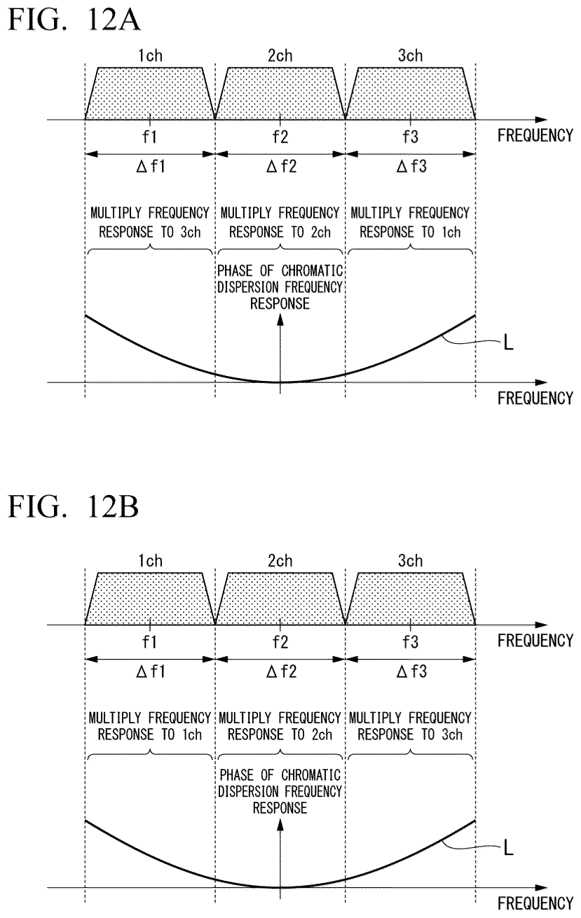

FIG. 12A is a first diagram showing an overview of determining the frequency response coefficient of the transmission line chromatic dispersion used in the frequency response multiplication portion 413, which is equalized according to the notified chromatic dispersion compensation amount and the carrier frequency and signal bandwidth of each channel. Suppose that the optical repeater 200 receives optical signals of the first channel 1ch, the second channel 2ch, and the third channel 3ch. The carrier frequencies for each channel are f1, f2, and f3, and the respective frequency bands are Δf1, Δf2, and Δf3. Curve L at the bottom of FIG. 12A shows the phase of the chromatic dispersion frequency response. The frequency response multiplication portion 413 multiplies the frequency response coefficient converted from the phase component to the complex component by the signal input from the fast Fourier transform portion 412. Note that a complex number coefficient such as that used for the frequency application coefficient can be obtained by computing exp(iθ) from the phase component θ as indicated by the curve L at the bottom of FIG. 12A. Phase conjugation processing is performed first in the digital signal processing portion 230, followed by chromatic dispersion compensation processing. Based on the frequency inversion due to phase conjugation and the chromatic dispersion frequency response of the entire received signal bandwidth (Δf1+Δf2+Δf3), the frequency response multiplication portion 413 of each channel of the optical repeater 200 multiplies the signal of each channel input from the fast Fourier transform portion 412 by the chromatic dispersion frequency response of each frequency band of each corresponding channel.

More specifically, the frequency response multiplication portion 413 specifies the coefficient in the region of Δf3 out of the chromatic dispersion frequency response of the entire bandwidth (Δf1+Δf2+Δf3) of the received signal as the frequency application coefficient for chromatic dispersion compensation to channel 1ch, and multiplies that coefficient by the signal input from the fast Fourier transform portion 412 corresponding to channel 1ch. The frequency response multiplication portion 413 specifies the coefficient in the region of Δf2 out of the chromatic dispersion frequency response of the entire bandwidth (Δf1+Δf2+Δf3) of the received signal as the frequency application coefficient for chromatic dispersion compensation to channel 2ch, and multiplies that coefficient by the signal input from the fast Fourier transform portion 412 corresponding to channel 2ch. The frequency response multiplier 413 specifies the coefficient in the region of Δf1 out of the chromatic dispersion frequency response of the entire bandwidth (Δf1+Δf2+Δf3) of the received signal as the frequency application coefficient for chromatic dispersion compensation to channel 3ch, and multiplies that coefficient by the signal input from the fast Fourier transform portion 412 corresponding to channel 3ch. This takes into account frequency component inversion due to the phase conjugation process.

FIG. 12B is a second diagram showing an overview of determining the frequency response coefficient of the transmission line chromatic dispersion used in the frequency response multiplication portion 413, which is equalized according to the notified chromatic dispersion compensation amount and the carrier frequency and signal bandwidth of each channel. Suppose that the optical repeater 200 receives optical signals of the first channel 1ch, the second channel 2ch, and the third channel 3ch. The carrier frequencies for each channel are f1, f2, and f3, and the respective frequency bands are Δf1, Δf2, and Δf3. The curve L at the bottom of FIG. 12b shows the phase of the chromatic dispersion frequency response, and the frequency response multiplication portion 413 multiplies the frequency response coefficient converted from the phase component to the complex component by the signal input from the fast Fourier transform portion 412. Chromatic dispersion compensation processing is performed first in the digital signal processing portion 230, followed by phase conjugation processing.

Based on the chromatic dispersion frequency response of the entire received signal bandwidth (Δf1+Δf2+Δf3), the frequency response multiplication portion 413 of each channel of the optical repeater 200 multiplies the signal of each channel input from the fast Fourier transform portion 412 by the chromatic dispersion frequency response of each frequency band of each corresponding channel. More specifically, the frequency response multiplication portion 413 specifies the coefficient in the region of Δf1 out of the chromatic dispersion frequency response of the entire bandwidth (Δf1+Δf2+Δf3) of the received signal as the frequency application coefficient for chromatic dispersion compensation to channel 1ch, and multiplies that coefficient by the signal input from the fast Fourier transform portion 412 corresponding to channel 1ch. The frequency response multiplication portion 413 specifies the coefficient in the region of Δf2 out of the chromatic dispersion frequency response of the entire bandwidth (Δf1+Δf2+Δf3) of the received signal as the frequency application coefficient for chromatic dispersion compensation to channel 2ch, and multiplies that coefficient by the signal input from the fast Fourier transform portion 412 corresponding to channel 2ch. The frequency response multiplier 413 specifies the coefficient in the region of Δf3 out of the chromatic dispersion frequency response of the entire bandwidth (Δf1+Δf2+Δf3) of the received signal as the frequency application coefficient for chromatic dispersion compensation to channel 3ch, and multiplies that coefficient by the signal input from the fast Fourier transform portion 412 corresponding to channel 3ch.

This enables the optical repeater 200 to also compensate for differences in group delay characteristics between channels in a case where receiving multi-channel signals, and to compensate for inter-channel nonlinear distortion due to phase conjugation.

The inverse fast Fourier transform portion 414 then performs the inverse fast Fourier transform (IFFT) to convert the signal into a time-domain signal. The overlap removal portion 415 removes the overlapping portion from the restored signal in the time domain and outputs it. In a case where using FDE, the chromatic dispersion compensation amount can be adjusted by changing the inverse transfer function. The overlap addition portion 411 and overlap removal portion 415 may be omitted.

Phase conjugation processing by digital signal processing finds the complex conjugate of the input digital signal. That is, the sign of the imaginary component Q in the Ix, Qx, Iy, and Qy signals is inverted as in the following Equation (1).

$$\begin{matrix}{I}_{X} = Re [ ( {I}_{X} − j {Q}_{x} ) {e}^{j ∅ 1} ] \\ {Q}_{X} = Im [ ( {I}_{X} − j {Q}_{x} ) {e}^{j ∅ 1} ] \\ {I}_{Y} = Re [ ( {I}_{Y} − j {Q}_{Y} ) {e}^{j ∅ 2} ] \\ {Q}_{Y} = Im [ ( {I}_{Y} − j {Q}_{Y} ) {e}^{j ∅ 2} ]\end{matrix} \} \qquad ( 1 )$$

The node control portion 202 receives control information from the control device 100 and controls each part of the optical repeater 200 based on the received control information. The node control portion 202 is an acquisition portion that acquires the optimal chromatic dispersion compensation amount according to each channel's frequency band from the chromatic dispersion compensation amount calculation portion 130, phase conjugation processing information from the phase conjugation determination portion 140, and reception wavelength information and transmission wavelength information from the carrier frequency control portion 150. The node control portion 202 sets the frequency (wavelength) of the local oscillator light r1 to the reception light source 240 based on the acquired reception wavelength information and sets the frequency of the transmission light r2 to the transmission light source 250 based on the acquired transmission wavelength information. The node control portion 202 sets the phase conjugation processing operation to the phase conjugation processing portion 232 based on control information including instructions to perform phase conjugation processing acquired from the control device 100. The node control portion 202 sets the chromatic dispersion compensation amount to the chromatic dispersion compensation portion 231 based on the optimal chromatic dispersion compensation amount that was acquired.

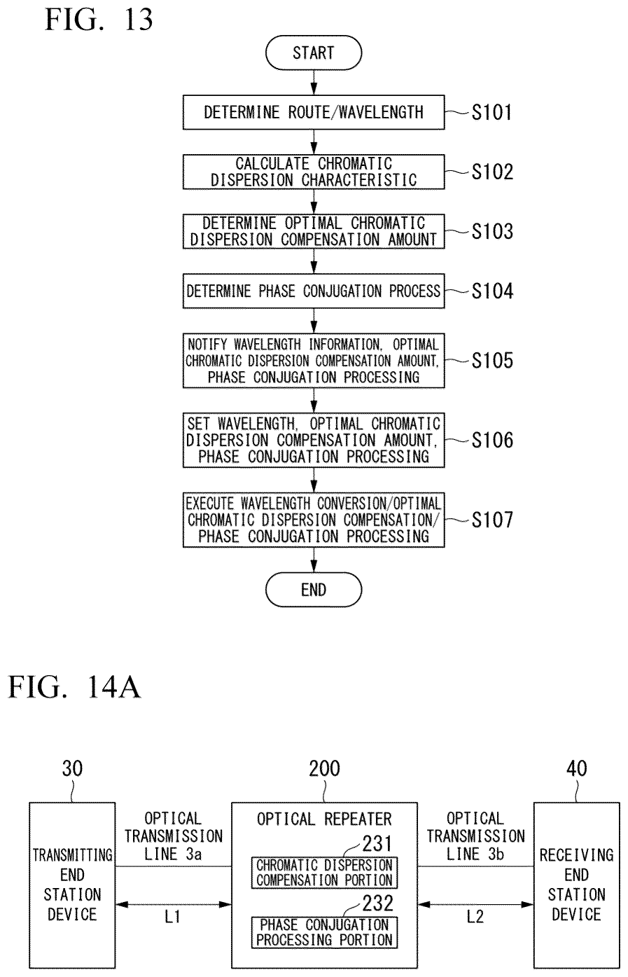

FIG. 13 shows an example of the operation of the optical network system according to the example embodiment of the present disclosure. As shown in FIG. 13, first, the network management portion 110 of the control device 100 determines the optical transmission line information of the front-stage and rear-stage optical transmission lines of the optical repeater 200. The carrier frequency control portion 150 determines the wavelength to be used by the optical repeater 200 (step S101). The network control portion 120 of the control device 100 determines the path route in the optical network 51 and identifies the optical transmission line and the optical repeaters 200 on the path route. By determining the wavelength of each optical transmission line that is identified, the carrier frequency control portion 150 determines the wavelengths of the front stage and rear stage (before and after conversion) in each optical repeater 200, i.e., the wavelengths of the optical signals transmitted and received by the optical repeater 200. The network control portion 120 and the carrier frequency control portion 150 output the reception wavelength information and transmission wavelength information of the optical repeater 200 according to the determined wavelengths to the chromatic dispersion compensation amount calculation portion 130, the phase conjugation determination portion 140, and the carrier frequency control portion 150, and also output the transmission line information (distance) of the front-stage and rear-stage optical transmission line of the optical repeater 200 to the chromatic dispersion compensation amount calculation portion 130 and the phase conjugation determination portion 140. If the path includes multiple optical repeaters 200, the following process is performed for each optical repeater.

Next, the chromatic dispersion compensation amount calculation portion 130 of the control device 100 calculates the chromatic dispersion characteristics in the front-stage and rear-stage optical transmission lines (step S102). The chromatic dispersion compensation amount calculation portion 130 calculates chromatic dispersion characteristic in the front-stage and rear-stage optical transmission lines of each optical repeater 200, based on the reception wavelength information and transmission wavelength information acquired from the network control portion 120 and the carrier frequency control portion 150 and the transmission line information (distance) of the front-stage and rear-stage optical transmission line of the optical repeater 200. If the transmission information includes the structure, type, and transmission characteristics of the optical fiber, the chromatic dispersion characteristic may be determined based on this information.

For example, the chromatic dispersion characteristic is the slope of the accumulated chromatic dispersion amount with respect to the distance of the optical transmission line (chromatic dispersion characteristic as a function of distance). Since the slope of the chromatic dispersion amount varies with wavelength, a table relating the wavelength (or wavelength band) to the slope of the chromatic dispersion may be stored in advance. The chromatic dispersion compensation amount calculation portion 130 may refer to this table to determine the chromatic dispersion characteristic corresponding to the wavelength.

Next, the chromatic dispersion compensation amount calculation portion 130 of the control device 100 determines the optimal chromatic dispersion compensation amount in the optical repeater 200 (step S103). The chromatic dispersion compensation amount calculation portion 130 determines the optimal chromatic dispersion compensation amount in the optical repeater 200 based on the chromatic dispersion characteristics of the front-stage and rear-stage optical transmission lines of the optical repeater 200 and the transmission line information of the front-stage and rear-stage optical transmission lines. The chromatic dispersion compensation amount calculation portion 130 calculates the chromatic dispersion amount accumulated in the optical transmission line in the front stage (reception side) and the chromatic dispersion amount accumulated in the optical transmission line in the rear stage (transmission side), and determines the optimum chromatic dispersion amount based on the front-stage and rear-stage chromatic dispersion amounts. In particular, the chromatic dispersion compensation amount calculation portion 130 determines the optimal chromatic dispersion amount based on the chromatic dispersion amount accumulated between the transmitting end station device 30 and the optical repeater 200 and the chromatic dispersion amount accumulated between the optical repeater 200 and the receiving end station device 40. For example, the chromatic dispersion compensation amount calculation portion 130 calculates the chromatic dispersion amount accumulated in the front-stage optical transmission line based on the chromatic dispersion characteristic and transmission line information (distance) of the front-stage optical transmission line of the optical repeater 200 and calculates the chromatic dispersion amount accumulated in the rear-stage optical transmission line based on the chromatic dispersion characteristic and transmission line information of the rear-stage optical transmission line of the optical repeater 200. Note that in this example, the chromatic dispersion compensation amount calculation portion 130 determines the chromatic dispersion compensation amount based on the chromatic dispersion characteristics and transmission line information, since the chromatic dispersion characteristic corresponds to wavelength information, the chromatic dispersion compensation amount may be determined based on wavelength information and transmission line information. In other words, the chromatic dispersion compensation amount calculation portion 130 may determine the chromatic dispersion compensation amount in the plurality of optical repeaters 200 comprising the path based on wavelength information and transmission line information in the path.

Next, the phase conjugation determination portion 140 of the control device 100 determines the optimal phase conjugation process in the optical repeater 200 (step S104). The phase conjugation determination portion 140 determines the optimal phase conjugation process in the optical repeater 200 based on the number of optical paths between the transmitting end station device 30 and the receiving end station device 40 in the optical network 51 and the number of optical repeaters 200.

Next, the control device 100 notifies the optical repeater 200 of the routing information, reception wavelength information and transmission wavelength information determined in step S101, the optimal phase conjugation processing information determined in step S104, and the optimal chromatic dispersion compensation amount determined in step S103 (step S105).

Next, the node control portion 202 of the optical repeater 200 sets the wavelength of the wavelength information, the phase conjugation processing information, and the optimal chromatic dispersion compensation amount notified by the control device 100 (step S106). The node control portion 202 sets the wavelength of the acquired reception wavelength information to the reception light source 240, the wavelength of the acquired transmission wavelength information to the transmission light source 250, the acquired phase conjugation processing information to the phase conjugation processing portion 232, and the acquired optimal chromatic dispersion compensation amount to the chromatic dispersion compensation portion 231.

Next, the optical repeater 200 performs wavelength conversion, phase conjugation processing, and chromatic dispersion compensation (step S107). The reception light source 240 generates a local oscillator light r1 of the set wavelength (frequency) and the transmission light source 250 generates a transmission light r2 of the set wavelength, thereby performing wavelength conversion in the optical transmitter/receiver 201. The phase conjugation processing portion 232 performs the phase conjugation processing by phase conjugation, and the chromatic dispersion compensation portion 231 performs the chromatic dispersion compensation processing based on the set compensation amount by performing digital signal processing on the signal after the phase conjugation processing.

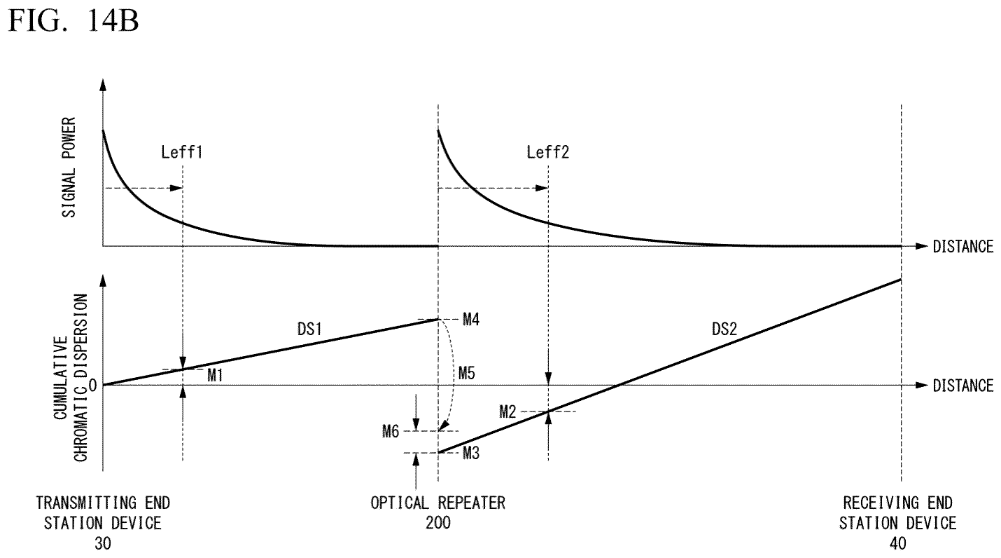

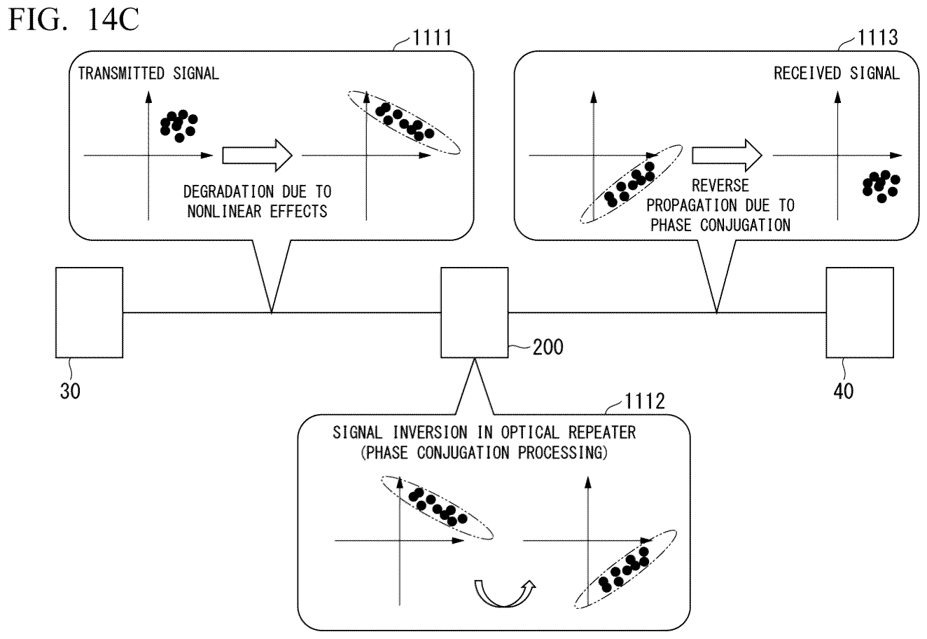

FIG. 14A and FIG. 14B show specific examples of phase conjugation processing and chromatic dispersion compensation processing by the control method of the one example embodiment of the present disclosure. In the present example embodiment, phase conjugation processing is performed in the optical repeater 200 on the nonlinear distortion accumulated in the front-stage optical transmission line in the optical signal received by the optical repeater 200. This allows the nonlinear distortion in the transmission of optical signals transmitted from the optical repeater 200 in the rear-stage optical transmission line to be cancelled out at the receiving end. To achieve this effect, the optical repeater 200 in the present example embodiment determines the optimal chromatic dispersion compensation amount such that the nonlinear distortion cancellation effect is maximized. The optimal chromatic dispersion compensation amount in this example is the compensation amount calculated based on the chromatic dispersion amount in the front-stage transmission line and the rear-stage transmission line for the optical repeater 200. In this example, the digital signal processing portion 230 of the optical repeater 200 determines the optimal chromatic dispersion compensation amount in a case where performing chromatic dispersion compensation processing after the phase conjugation processing. Even in a case where the digital signal processing portion 230 performs phase conjugation processing after the chromatic dispersion compensation processing, it may similarly determine the optimal chromatic dispersion compensation amount based on the chromatic dispersion amount in the front-stage and rear-stage transmission lines. In this example, the phase conjugation processing is performed first in the digital signal processing portion 230, followed by the chromatic dispersion compensation processing.

As shown in FIG. 14A, in this example, one optical repeater 200 is located on the path between the transmitting end station device 30 and the receiving end station device 40. The transmitting end station device 30 and the optical repeater 200 are connected via the optical transmission line 3a (first optical transmission line), and the optical repeater 200 and the receiving end station device 40 are connected via the optical transmission line 3b (second optical transmission line). For example, the distance L1 of optical transmission line 3a and the distance L2 of optical transmission line 3b are different; with the distance L2 of the optical transmission line 3b being longer than the distance L1 of the optical transmission line 3a, but they may also be the same distance. Optical signals of wavelength λ1 are transmitted in the optical transmission line 3a, and optical signals of wavelength λ2 are transmitted in the optical transmission line 3b. For example, wavelengths λ1 and λ2 may both be in the C-band wavelength band, or they may be different, such as C-band and L-band wavelength bands, respectively, or they may both be in the L-band wavelength band. The optical repeater 200 converts the optical signal of wavelength λ1 that is received into an optical signal of wavelength λ2, and transmits the converted optical signal of wavelength λ2.

As shown in FIG. 14B, since the wavelength of the optical signal is λ1 in the front-stage optical transmission line 3a, the chromatic dispersion compensation amount calculation portion 130 of the control device 100 determines the slope DS1 of the chromatic dispersion amount in the optical transmission line 3a according to the wavelength λ1. The slope DS1 of the chromatic dispersion amount in the optical transmission line 3a may be read from a database or other storage means. The chromatic dispersion compensation amount calculation portion 130 of the control device 100 uses the slope DS1 of the chromatic dispersion amount and the effective nonlinear distance Leff1 in the optical transmission line 3a to obtain the accumulated chromatic dispersion amount M1 (=DS1×Leff1) at the effective nonlinear distance Leff1 in the front-stage optical transmission line 3a. Since nonlinear effects are effects that depend on the optical signal intensity, and the optical intensity in a transmission line decreases according to an exponential shape characterized by a propagation loss constant, it is sufficient to consider nonlinear effects only in regions of high optical intensity. The effective nonlinear distance Leff is defined as the distance at which nonlinear effects are considered, and Leff is given by the following Equation (2) using the length L and the propagation loss constant α in the optical fiber.

$$Leff = \frac{1 - {e}^{- α L}}{2 α} \qquad ( 2 )$$

Since the wavelength of the optical signal in the rear-stage optical transmission line 3b is λ2, the chromatic dispersion compensation amount calculation portion 130 of the control device 100 determines the slope DS2 of the chromatic dispersion amount in the optical transmission line 3b according to the wavelength λ2. The slope DS2 of the chromatic dispersion amount in optical transmission line 3b may be read from a database or other storage means. The chromatic dispersion compensation amount calculation portion 130 of the control device 100 calculates the accumulated chromatic dispersion amount M2 at the effective nonlinear distance Leff2 in the rear-stage optical transmission line 3b as M2=−M1, on the condition of having a different sign from the accumulated chromatic dispersion amount M1 at the effective nonlinear distance Leff1 in the front-stage optical transmission line 3a. The chromatic dispersion compensation amount calculation portion 130 then finds the accumulated chromatic dispersion amount M3 in the transmission signal of the optical repeater. M3 can be calculated by M3=M2+DS2×Leff2=DS1×Leff1+DS2×Leff2.

The chromatic dispersion compensation amount calculation portion 130 of the control device 100 then determines the cumulative chromatic dispersion compensation amount M5 for the optical repeater 200 to compensate chromatic dispersion using phase conjugation by M5=M4×2.

The chromatic dispersion compensation amount calculation portion 130 of the control device 100 finds the difference M6 between the accumulated chromatic dispersion amount M3 and the cumulative chromatic dispersion compensation amount M5, and transmits the difference M6 to the optical repeater 200 as the optimal chromatic dispersion compensation amount. The control device 100 also transmits control information including instructions to implement the phase conjugation process to the optical repeater 200. As a result, the node control portion 202 of the optical repeater 200 instructs the phase conjugation processing portion 232 to perform the phase conjugation processing operation based on the control information including the acquired instruction to perform the phase conjugation processing, as explained using FIGS. 9 and 11. The phase conjugation processing portion 232 performs the phase conjugation processing operations. The node control portion 202 of the optical repeater 200 sets the chromatic dispersion compensation amount M6 notified by the control device 100 to the chromatic dispersion compensation portion 231 in the digital signal processing portion 230, as described using FIG. 9. In other words, in a case where the chromatic dispersion compensation portion 231 is configured with an FDE as shown in FIG. 9, the node control portion 202 sets the transfer function coefficient of the inverse transfer function multiplication portion 413 in FIG. 9 according to the chromatic dispersion compensation amount M6 notified from the control device 100. As a result, the optical repeater 200, for the rear-stage optical transmission line 3b, calculates the cumulative chromatic dispersion M3 (M3=M4−M5−M6) after calculation of the cumulative chromatic dispersion compensation amount M5 using the phase conjugation processing of the phase conjugation processing portion 232 and the chromatic dispersion compensation using the chromatic dispersion compensation amount M6 of the chromatic dispersion compensation portion 231, and outputs an optical signal that is the cumulative chromatic dispersion M3 (FIG. 14B). This suppresses nonlinear effects in the receiving end station device 40.

The optical repeater 200 can calculate the accumulated chromatic dispersion amount M3 without phase conjugation by M3=M2+DS2×Leff2=DS1×Leff1+DS2×Leff2. Accordingly, the chromatic dispersion compensation portion 231 of the optical repeater 200 may calculate the relevant accumulated chromatic dispersion amount M3 and output an optical signal that is the relevant cumulative chromatic dispersion amount M3 without phase conjugation (FIG. 14B). In the explanation of FIGS. 12A and 12B, for convenience of explanation, it is explained that the optical signal of wavelength λ1 is transmitted in the optical transmission line 3a and the optical signal of wavelength λ2 is transmitted in the optical transmission line 3b, but multi-channel optical signals of multiple wavelengths λ (frequency bands) may be transmitted in the optical transmission line 3a, and multi-channel optical signals of multiple wavelengths λ (frequency bands) may be transmitted in the optical transmission line 3b.

FIG. 14C is a diagram showing an overview of the phase conjugation process.

As shown in FIG. 14C, at a certain span in the optical network 51 (between network devices such as the transmitting end station device 30 and the optical repeater 200 in FIG. 14C), nonlinear distortion of the transmitted signal occurs as signal degradation due to nonlinear effects (1111 in FIG. 14C). Phase conjugation processing (inversion of the optical signal) is performed at the optical repeater 200 (1112 in FIG. 14C). This enables the phase conjugation to be used to cancel out the nonlinear distortion in the span following the optical repeater 200 (between the optical repeater 200 and the receiving end station device 40), thereby reducing signal degradation (nonlinear distortion) at the receiving end station device 40 (1113 in FIG. 14C). In addition to this, optimal chromatic dispersion compensation for each channel's signal bandwidth in a case where the optical repeater 200 receives multi-channel signals can be used to maximize the cancellation effect of nonlinear distortion at the receiving end station device 40.

The aforementioned processing in the control device 100 described above is an example aspect of processing that determines the chromatic dispersion compensation amount for compensation in the optical repeater 200 based on the wavelength information of the optical signal transmitted and received by the optical repeater 200 that is included in the optical network in the optical network path and the transmission line information of the optical transmission line connected to the optical repeater 200, and determines the phase conjugation processing in the optical repeater 200 based on the wavelength information and transmission line information.

Some of the processing in the control device 100 is an example aspect of processing that transmits to the optical repeater 200 an instruction to perform phase conjugation processing to calculate the complex conjugation of the optical signal concerned based on the accumulated chromatic dispersion amount M4 of the optical signal received by the optical repeater 200.

Some of the processing in the control device 100 is an example aspect of processing that calculates the first accumulated chromatic dispersion amount M1 at a first effective nonlinear distance (Leff1) with reference to the transmission-side network device in a first optical transmission line (front-stage path) between a transmission-side network device that transmits an optical signal received by the optical repeater 200 among the optical transmission lines to which the optical repeater 200 is connected.

Some of the processing in the control device 100 is an example aspect of processing that calculates a second accumulated chromatic dispersion amount (M2) at a second effective nonlinear distance (Leff2) with reference to the own device of the optical signal in the second optical transmission line (rear-stage path) between the reception-side network device of the optical signal transmitted by the optical repeater 200 among the optical transmission lines to which the optical repeater 200 is connected, the second accumulated chromatic dispersion amount having the opposite sign (multiplied by −1) of the first accumulated chromatic dispersion amount.

Some of the processing in the control device 100 is an example aspect of processing that calculates the chromatic dispersion compensation amount (M6), which indicates the difference between the chromatic dispersion amount (M3) during transmission of an optical signal in the optical repeater 200 in a case where the accumulated chromatic dispersion amount of an optical signal becomes the second accumulated chromatic dispersion amount (M2) at the second effective nonlinear distance (Leff2) based on a statistical value (DS2) of the transition of the accumulated chromatic dispersion amount of an optical signal according to the distance in a second optical transmission line and the chromatic dispersion amount (M5) resulting from complex conjugation.

The processing of the optical repeater 200 described above is an example aspect of processing that performs chromatic dispersion compensation processing on an electrical signal based on a received optical signal, based on the chromatic dispersion compensation amount (M6), and performs phase conjugation processing on an electrical signal based on a received optical signal, based on phase conjugation processing information acquired from the control device 100.

Some of the processing described above in the optical repeater 200 is an example aspect of processing that performs phase conjugation processing based on the accumulated chromatic dispersion amount of an optical signal received by the own device and an instruction to perform phase conjugation processing in order to calculate the complex conjugation of the optical signal.

Some of the processing in the optical repeater 200 described above is an example aspect of processing to determine the chromatic dispersion amount (M3) of an optical signal transmitted to the reception-side network device, based on the chromatic dispersion amount (M5), which is the result of the complex conjugation after the phase conjugation processing, and the chromatic dispersion compensation amount (M6) acquired from the control device 100.

In the digital signal processing of the optical repeater 200 described above, in a case where an optical signal consisting of one or more optical channels is received, phase conjugation processing and chromatic dispersion compensation can be performed on a channel-by-channel basis. However, even if the rotation angle of the light polarization is not uniform on a channel-by-channel basis, the reception characteristics of light in other optical repeaters 200 and receiving end station devices 40 on the reception side in the rear stage may deteriorate. The reception characteristics are expressed by the Q value (Quality Factor). The Q factor can be measured at the reception side by known techniques.

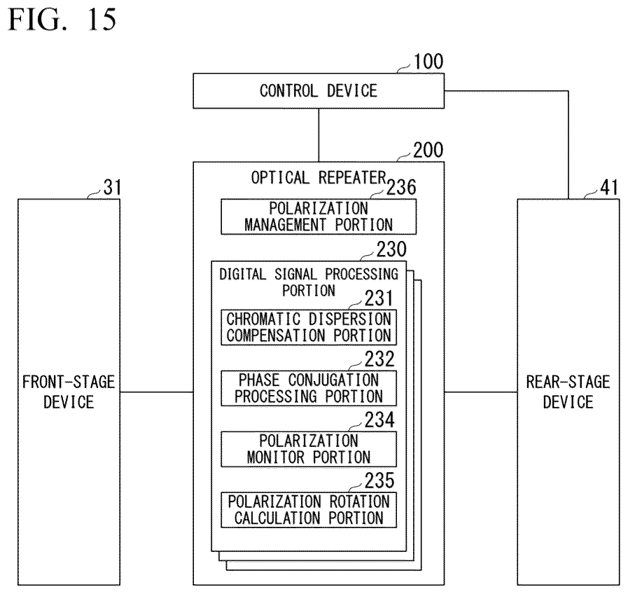

FIG. 15 is a diagram illustrating another example configuration of each device in the optical network system according to an example embodiment of the present disclosure.

The digital signal processing portion 230 of the optical repeater 200 may further include the functions of a polarization monitor portion 234 and a polarization rotation calculation portion 235 as shown in FIG. 15, in addition to the chromatic dispersion compensation portion 230 and the phase conjugation processing portion 232. As shown in FIG. 10, the digital signal processing portion 230 may have the function of a delay adjustment portion 233. The digital signal processing portion 230 of the optical repeater 200 may at least fulfill the functions of the polarization monitor portion 234 and the polarization rotation calculation portion 235. In the present disclosure, the optical repeater 200 includes digital signal processing portions 230, the number of which corresponds to the number of channels included in the optical signal, and each digital signal processing portion 230 performs signal processing for the corresponding channel. The optical repeater 200 is further provided with a polarization management portion 236.

The optical repeater 200 is communicatively connected to a front-stage device 31, a rear-stage device 41, and the control device 100. The front-stage device 31 may be another optical repeater 200 or the transmitting end station device 30 in the front stage of the optical repeater 200 in the optical network. The rear-stage device 41 may be another optical repeater 200 or a receiving end station device 40 in the rear stage of the optical repeater 200 in the optical network.

The digital signal processing portion 230 of the optical repeater 200 may use the functions of the polarization monitor portion 234 and the polarization rotation calculation portion 235 to perform processing to reduce deterioration of the optical reception characteristics in other optical repeaters 200 and the receiving end station device 40 on the reception side in the rear stage, even if the rotation angle of the light polarization is not uniform on a channel-by-channel basis. This process will be described below. Incidentally, unevenness in the degree of polarization rotation between channels may occur in a case where an optical signal consisting of one or more optical channels is separated into each channel, or may occur because the optical characteristics of the conductor portions of each optical channel after separation differ between the channels.

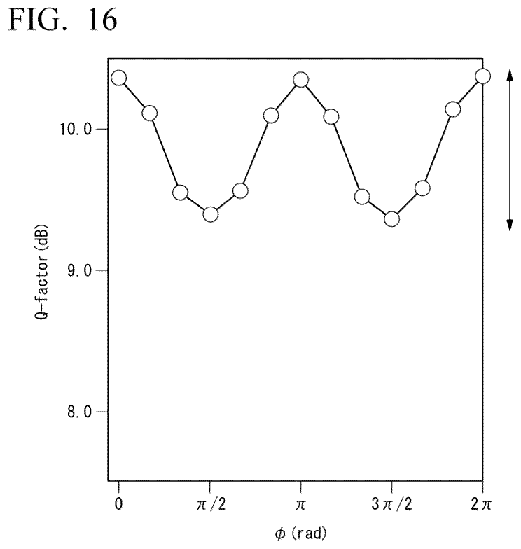

FIG. 16 is a diagram showing a change in the reception characteristic of one of the two signal channels included in the optical signal according to the difference in the rotation angle of the polarization generated in the repeater 200 for the two signal channels. As an example, as shown in FIG. 16, in a case where a deviation occurs in the rotation angle of the polarization of two signal channels included in an optical signal, the Q value of each channel increases or decreases. For example, in FIG. 16, in a case where the difference in the rotation angle of the polarization of two signal channels is 0, π, or 2π, the Q value of each channel is high. On the other hand, in FIG. 16, in a case where the difference in the rotation angles of the polarization of the two signal channels is 1/2π or 3/2π, it can be seen that the Q value of each channel is relatively low. In a case where the difference in the rotation angle of the polarization of the two signal channels is 1/2π or 3/2π, it indicates that the two signal channels are orthogonal to each other. As in each of the disclosed examples of the optical repeater 200 described above, while nonlinear distortion compensation by phase conjugation of the optical repeater 200 can be expected to have the effect of compensating for the polarization interaction component in the inter-channel nonlinear distortion, in a case where orthogonal polarization rotation occurs in the two signal channels within the optical repeater 200, since the compensation effect for the polarization interaction component in the inter-channel nonlinear distortion is reduced, the Q value decreases in a case where a deviation of 1/2π or 3/2π occurs in the polarization rotation angles of the two signal channels, as shown in FIG. 16. The change in the Q value based on the difference (deviation) in the rotation angles of the polarization of the two signal channels does not need to be limited to the mode shown in FIG. 16.

Here, the polarization monitor portion 234 monitors a rotation angle from a reference angle of polarization indicated by each of a plurality of signal channels included in an optical signal.

The polarization rotation calculation portion 235 adjusts the rotation angle from a reference angle of polarization of each signal channel to a rotation angle that improves the reception characteristics of each signal channel by using a control value that controls the rotation angle from a reference angle of polarization of any one of the plurality of signal channels.

The polarization monitor portion 234 controls the polarization monitor portion 234 and the polarization rotation calculation portion 235 of each digital signal processing portion 230.

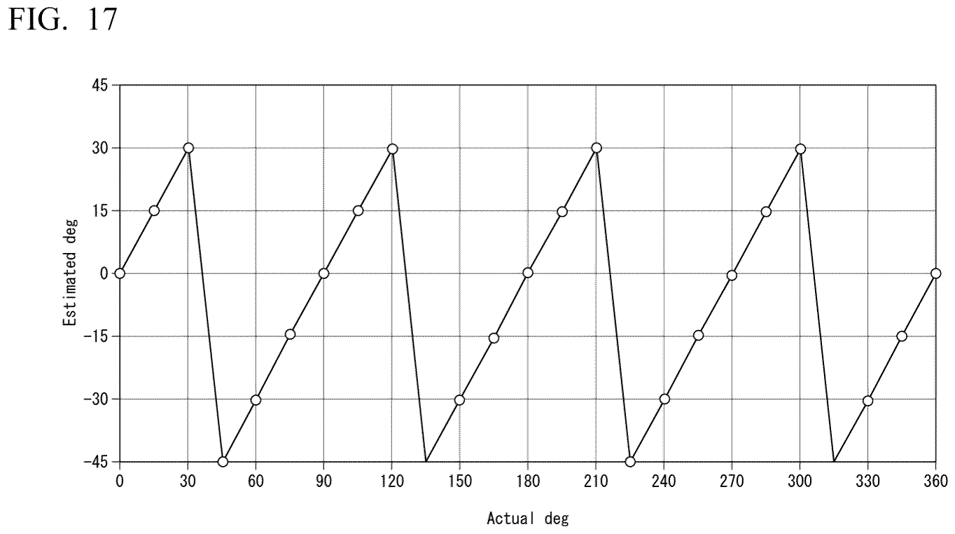

FIG. 17 is a diagram showing the monitor characteristic of the polarization monitor portion.

As shown in FIG. 17, the polarization monitor portion 234 detects the rotation angle from a reference angle of the polarization of one signal channel that is responsible for processing among a plurality of signal channels included in an optical signal. At this time, as shown in FIG. 17, the polarization monitor portion 234 outputs the detected rotation angle (estimated deg) that has a different value from the actual rotation angle (actual deg) from the reference angle of the polarization. Specifically, in a case where the rotation angle from the reference angle of the actual polarization is 0°, 15°, or 30°, the detected rotation angle can also be output as 0°, 15°, or 30°, respectively, but in a case where the rotation angle from the reference angle of the actual polarization is 45°, 60°, 75°, or 90°, the detected rotation angle is output as −45°, −30°, −15°, or 0°, respectively.

Although not shown in FIG. 17, in a case where the rotation angle of the actual polarization from the reference angle (actual deg) is 0°≤actual deg<45°, the polarization monitor portion 234 can output the detected rotation angle φ as the same value as the rotation angle (actual deg) of the actual polarization from the reference angle. In this way, the polarization monitor portion 234 has the characteristic of outputting the same value as the detected rotation angle in a case where the rotation angle of the actual polarization from the reference angle is within the range of 0°≤Actual deg<45°, and outputting a value obtained by subtracting 90° from that value as the detected rotation angle in a case where the rotation angle of the actual polarization from the reference angle is within the range of 45°≤Actual deg<90°. In other words, the output value (detected rotation angle φ) of the polarization monitor portion 234 takes a value in the range of −45°≤detected rotation angle φ<+45°. Moreover, every time the rotation angle of the actual polarization from the reference angle (actual deg) increases by π/2, a similar output state of the polarization monitor portion 234 is repeated. This characteristic is an example of a polarization monitor using an adaptive equalization algorithm that uses an FIR filter having a 2×2 butterfly structure for a QPSK signal, and is a characteristic of a known polarization monitor function. The monitoring characteristic of the polarization rotation angle of the polarization monitor portion 234 is not limited to that shown in FIG. 17, but similarly has a characteristic that the output monitor value is limited to a range of 90°. In addition, the polarization monitor portion 234 may be able to directly detect the rotation angle of the reference angle of the actual polarization and output it as the detected rotation angle.

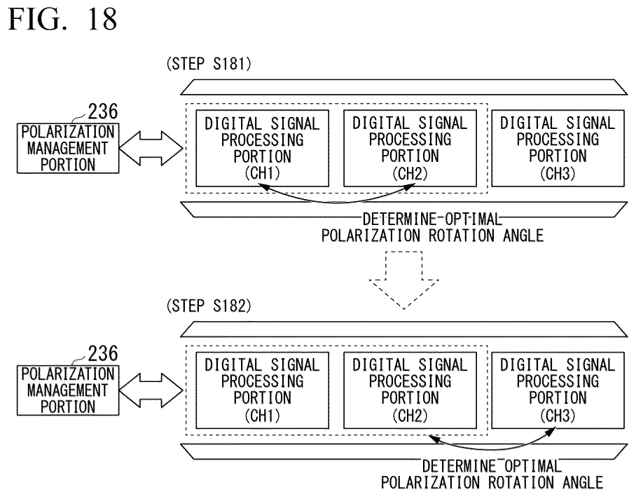

FIG. 18 is a diagram showing an outline of a process for matching the rotation angles of the signal channels in the digital signal processing portion.

For example, it is assumed that an optical signal includes three signal channels: a first signal channel (CH1), a second signal channel (CH2), and a third signal channel (CH3). In this case, the polarization rotation calculation portion 235 acquires the control value generated by the control device 100 based on the transmission to the control device 100 of the detected rotation angles of the first signal channel (CH1) and the second signal channel (CH2) acquired by the polarization management portion 236 from the polarization monitor portion 234 corresponding to the signal channel. This control value may be obtained by the control device 100 acquiring from the rear-stage device 41 the reception characteristics of the first signal channel (CH1) and the second signal channel (CH2) in the rear-stage device 41, and the signal channel identifier and compensation rotation angle for achieving a reception characteristic with a good value among those reception characteristics may be stored by the control device 100. The polarization rotation calculation portion 235 uses the signal channel identifier and compensation rotation angle value indicated by the acquired control value to align the rotation angles from the reference angle of each polarization of the first signal channel (CH1) and the second signal channel (CH2) (step S181). At this time, among the rotation angle from the reference angle of the polarization of the first signal channel (CH1) and the rotation angle from the reference angle of the polarization of the second signal channel (CH2), the polarization rotation calculation portion 235 adjusts one of the rotation angle from the reference angle of polarization of the first signal channel (CH1) and the rotation angle from the reference angle of polarization of the second signal channel (CH2) to the other, based on the control value, at the rotation angle with good reception characteristics in the reception-side device. Specifically, in a case where the control value includes an identifier of the first signal channel (CH1), the polarization rotation calculation portion 235 aligns the rotation angle from the reference angle of the polarization of the second signal channel (CH2) to the rotation angle from the reference angle of the polarization of the first signal channel (CH1). Alternatively, if the control value includes an identifier of the second signal channel (CH2), the polarization rotation calculation portion 235 aligns the rotation angle from the reference angle of the polarization of the first signal channel (CH1) to the rotation angle from the reference angle of the polarization of the second signal channel (CH2). For convenience, the rotation angle after the rotation angles of the two signal channels have matched is referred to as a first integrated rotation angle.

In addition, the polarization rotation calculation portion 235 acquires a control value generated by the control device 100 based on the detected rotation angle of the third signal channel (CH3) acquired by the polarization management portion 236 from the polarization monitor portion 234 corresponding to the signal channel and transmitted to the control device 100. This control value may be the result of the control device 100 acquiring from the rear-stage device 41 the reception characteristics of the first signal channel (CH1), the second signal channel (CH2) and the third signal channel (CH3) in the rear-stage device 41, and the signal channel identifier and compensation rotation angle for achieving a reception characteristic with a good value among those reception characteristics may be stored by the control device 100. The polarization rotation calculation portion 235 uses the signal channel identifier and compensation rotation angle indicated by the acquired control value to align the first integrated rotation angle with the rotation angle from the reference angle of the polarization of the third signal channel (CH3) (step S182). At this time, among the rotation angle from the reference angle of the polarization of the first signal channel (CH1), the rotation angle from the reference angle of the polarization of the second signal channel (CH2), and the rotation angle from the reference angle of the polarization of the third signal channel (CH3), the polarization rotation calculation portion 235 adjusts one of the rotation angles from the first integrated rotation angle and the reference angle of polarization of the third signal channel (CH3) to the other, based on the control value, at the rotation angle with good reception characteristics in the rear-stage device 41. Specifically, in a case where the control value includes an identifier of the first signal channel (CH1) or the second signal channel (CH2), the polarization rotation calculation portion 235 aligns the rotation angle from the reference angle of the polarization of the third signal channel (CH3) to the first integrated rotation angle. Alternatively, if the control value includes an identifier of the third signal channel (CH3), the polarization rotation calculation portion 235 aligns the rotation angle (first integrated rotation angle) from the reference angle of the polarization of the first signal channel (CH1) and the second signal channel (CH2) to the rotation angle from the reference angle of the polarization of the third signal channel (CH3). By the above processing, it is possible to match the rotation angles of the polarization of the first signal channel (CH1), the second signal channel (CH2), and the third signal channel (CH3) from the reference angle. In addition, in a case where the optical signal includes four or more signal channels, the polarization rotation calculation portion 235 controls the rotation angles from the reference angle of the polarization of all signal channels to be the same, in the same manner and sequentially, in accordance with the rotation angle from the reference angle of the polarization with good reception characteristics.

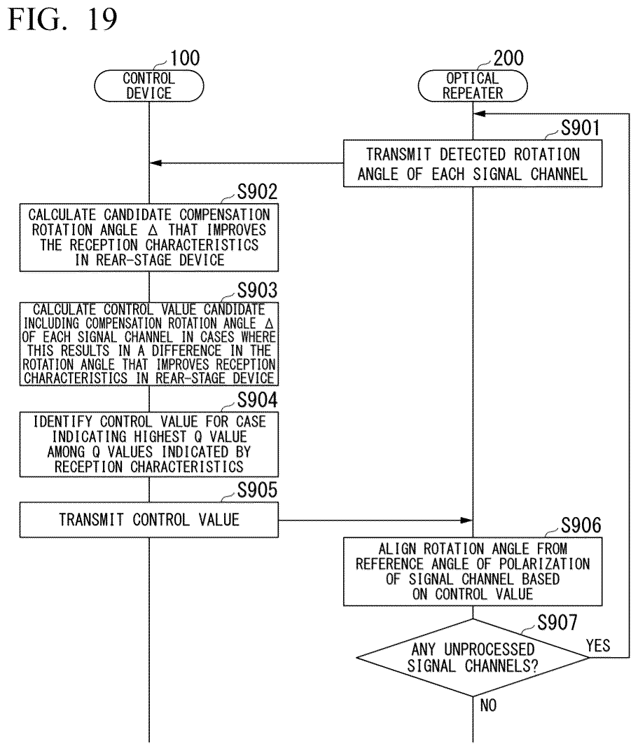

FIG. 19 is a diagram showing a process flow of the optical network system.

In the optical repeater 200, the polarization monitor portion 234 of each digital signal processing portion 230 responsible for processing each signal channel detects the rotation angle (detected rotation angle) of the polarization of the acquired signal channel from a reference angle. Each polarization monitor portion 234 outputs the detected rotation angle of the signal channel being processed to the polarization management portion 236. The polarization management portion 236 outputs the detected rotation angle of each signal channel to the control device 100 (step S901).

It is now assumed that an optical signal includes three channels: a first signal channel (CH1), a second signal channel (CH2), and a third signal channel (CH3). In this case, the polarization management portion 236 calculates a detected rotation angle φ1 from the reference angle of the polarization of the first signal channel (CH1) by the polarization monitor portion 234.

Similarly, for a second signal channel (CH2) indicating a frequency band adjacent to the first signal channel (CH1), the polarization management portion 236 calculates a detected rotation angle φ2 from the reference angle of the polarization of the second signal channel (CH2).

The polarization management portion 236 calculates candidate compensation rotation angles Δ such that the difference between the actual rotation angle of the first signal channel (CH1) and the rotation angle of the second signal channel (CH2) is 0° or 180° (π), that is, candidates Δ1 and Δ2 of compensation rotation angles such that the difference between the rotation angle of the first signal channel (CH1) and the rotation angle of the second signal channel (CH2) is 0° or 180° (π) so as to improve the reception characteristics as shown in FIG. 16.

Of the two compensation rotation angle candidates Δ1 and Δ2 calculated below, in a case where one candidate is applied to the second signal channel (CH2) relative to the signal characteristics (reception characteristics) before compensation, the signal characteristics deteriorate, and in a case where the other candidate, which is shifted by 90° from the compensation rotation angle candidate, is applied to the second signal channel (CH2), the signal characteristics improve. The latter signal has improved characteristics at an optimal compensation rotation angle. However, in the case where the difference between the actual rotation angles of the first signal channel CH1 and the second signal channel CH2 is already 0° or 180° before compensation, in a case where one of the two compensation rotation angle candidates Δ1, Δ2 is applied to the second signal channel (CH2), the signal characteristics will deteriorate, whereas in a case where the other candidate is applied to the second signal channel (CH2), the signal characteristics will remain unchanged from before compensation, and the latter will be the optimal compensation rotation angle.

That is, the polarization management portion 236 calculates a candidate compensation rotation angle Δ that improves the reception characteristics in the rear-stage device 41 based on the rotation angle from the reference angle of polarization of a first signal channel among the multiple signal channels and the rotation angle from the reference angle of polarization of a second signal channel among the multiple signal channels (step S902). In this process, since it is sufficient to set the polarization angle difference between the first signal channel (CH1) and the second signal channel (CH2) to 0° or 180° (π), there is no need to estimate the actual angle between the first signal channel (CH1) and the second signal channel (CH2), and the optimal compensation angle can be estimated with fewer executions.

Therefore, the polarization management portion 236 calculates the compensation rotation angle candidates Δ1 and Δ2 according to the following equations.

$$Δ 1 = φ 1 − φ 2$$

$$Δ 2 = φ 1 − φ 2 + 90 °$$

Below, as an example, a case will be shown in which the rotation angle of the actual polarization of the first signal channel (CH1) with respect to the reference angle is 30°, and the rotation angle of the actual polarization of the second signal channel (CH2) with respect to the reference angle is 150°. At this time, from FIG. 17, the monitor values (detected rotation angles) are φ1=30° and φ2=−30°. From the above calculation formula, the candidates Δ for the compensation rotation angle are Δ1=60°, and Δ2=φ1−φ2+90°=150°.

### (Case 1)

A compensation rotation angle Δ1 for the second signal channel (CH2) is calculated. In other words, by making a change of Δ1 to the actual rotation angle of the polarization of the second signal channel (CH2) from the reference angle (an increase of Δ1), the difference in the rotation angle of the polarization of the first signal channel (CH1) and the second signal channel (CH2) from the reference angle becomes 180° (π), and the value of the reception characteristic (Q value) is improved in the rear-stage device 41 as shown in FIG. 16.

### (Case 2)

A compensation rotation angle Δ2 for the second signal channel (CH2) is calculated. In other words, by making a change of Δ2 to the actual rotation angle of the polarization of the second signal channel (CH2) from the reference angle (an increase of Δ2), the difference in the rotation angle of the polarization of the first signal channel (CH1) and the second signal channel (CH2) from the reference angle becomes 270° (π3/2), and the value of the reception characteristic (Q value) in the rear-stage device 41 deteriorates as shown in FIG. 16.

By comparing the reception characteristic Q values of case 1 and case 2, the optimal compensation rotation angle is determined. In this example, Δ1 in case 1 is the optimal compensation rotation angle.

### (Processing Assuming Case 1)

Assuming the above-mentioned case 1, the polarization management portion 236 outputs an implementation request to the polarization rotation calculation portion 235, which includes an identifier of the first signal channel (CH1), an identifier of the second signal channel (CH2), an identifier of the second signal channel whose polarization is to be rotated among those signal channels, and a compensation rotation angle Δ1. The polarization rotation calculation portion 235 adds the compensation rotation angle Δ1 to the polarization rotation angle of the second signal channel (CH2) based on the identifier of the second signal channel (CH2) whose polarization is to be rotated, which is included in the execution request. The polarization rotation calculation portion 235 outputs a measurement request for the reception characteristic value (Q value) in the rear-stage device 41 to the polarization management portion 236. The polarization management portion 236 outputs to the control device 100 a measurement request for a reception characteristic value (Q value) including the identifier of the first signal channel (CH1) and the identifier of the second signal channel (CH2). The rear-stage device 41 outputs the reception characteristic of each channel to the control device 100. Therefore, the network control portion 120 of the control device 100 receives the reception characteristic (Q value) of the first signal channel (CH1) and the second signal channel (CH2). The network control portion 120 of the control device 100 temporarily stores, in a state in which the compensation rotation angle Δ1 is added to the polarization rotation angle of the second signal channel (CH2), the first reception characteristic (Q value) of the first signal channel (CH1) and the second signal channel (CH2), the case number of case 1 (a number indicating processing assuming case 1), and the compensation rotation angle+Δ1 in association with each other.

### (Processing Assuming Case 2)

Assuming the above-mentioned case 2, the polarization management portion 236 outputs an implementation request to the polarization rotation calculation portion 235, which includes an identifier of the first signal channel (CH1), an identifier of the second signal channel (CH2), an identifier of the second signal channel whose polarization is to be rotated among those signal channels, and a compensation rotation angle Δ2. The polarization rotation calculation portion 235 adds the compensation rotation angle Δ2 to the polarization rotation angle of the second signal channel (CH2) based on the identifier of the second signal channel (CH2) whose polarization is to be rotated, which is included in the execution request. The polarization rotation calculation portion 235 outputs a measurement request for the reception characteristic value (Q value) in the rear-stage device 41 to the polarization management portion 236. The polarization management portion 236 outputs to the control device 100 a measurement request for a reception characteristic value (Q value) including the identifier of the first signal channel (CH1) and the identifier of the second signal channel (CH2). The rear-stage device 41 outputs the reception characteristic of each channel to the control device 100. Therefore, the network control portion 120 of the control device 100 receives the reception characteristic (Q value) of the first signal channel (CH1) and the second signal channel (CH2). The network control portion 120 of the control device 100 temporarily stores, in a state in which the compensation rotation angle Δ2 is added to the polarization rotation angle of the second signal channel (CH2), the third reception characteristic (Q value) of the first signal channel (CH1) and the second signal channel (CH2), the case number of case 2 (a number indicating processing assuming case 2), and the compensation rotation angle +Δ2 in association with each other.

That is, in the processing assuming case 1 and the processing assuming case 2, the network control portion 120 of the control device 100 calculates candidates for control values including a compensation rotation angle Δ indicating the rotation angle from the reference angle of the polarization of each signal channel, in cases where this results in a difference in the rotation angle that improves reception characteristics in the rear-stage device 41 (step S903). For example, in the case of processing assuming case 1, the compensation rotation angle of the first signal channel is 0, and the compensation rotation angle of the second signal channel is +Δ1. In the case of processing assuming case 2, the compensation rotation angle of the first signal channel is 0, and the compensation rotation angle of the second signal channel is +Δ2.

The polarization management portion 236 detects the completion of transmission of measurement requests for all cases, case 1 to case 2, which are assumed cases for determining whether the reception characteristics will improve by adding a compensation rotation angle change to the rotation angle of the polarization of the second signal channel (CH2) without moving the polarization of the first signal channel (CH1). The polarization management portion 236 outputs the completion of the measurement request transmission to the control device 100.

The network control portion 120 of the control device 100 identifies the case number having the highest Q value among the Q values indicated by the stored first and second reception characteristics. That is, in this process, the network control portion 120 of the control device 100 identifies a control value including a compensation rotation angle Δ indicating the rotation angle of the polarization of the signal channel from the reference angle in a case where the Q value indicated by the reception characteristics is the highest Q value (step S904).

The control device 100 transmits a control value including the identified case number and the compensation rotation angle for that case number to the optical repeater 200 (step S905). The polarization management portion 236 of the optical repeater 200 acquires the control value and outputs the control value to the polarization rotation calculation portion 235. The processing of this polarization management portion 236 involves acquiring, from the control device 100, a control value including a rotation angle from a reference angle of polarization of each signal channel, which is the rotation angle calculated by the control device 100 based on the reception characteristics of each of the multiple signal channels received from the rear-stage device 41, and results in a difference in the rotation angle that improves the reception characteristics in the rear-stage device 41. The polarization rotation calculation portion 235 of the optical repeater 200 uses the case number and the compensation rotation angle for that case number to align the rotation angles from the reference angle of the polarization of the first signal channel (CH1) and the second signal channel (CH2) (step S906). For example, it is assumed that the control value includes the case number of case 1 (a number indicating processing assuming case 1) and a compensation rotation angle Δ1. In this case, the polarization rotation calculation portion 235 adds the compensation rotation angle Δ1 to the rotation angle of the polarization of the second signal channel (CH2) to control and fix the difference between the rotation angle from the reference angle of the polarization of the first signal channel (CH1) and the rotation angle from the reference angle of the polarization of the second signal channel (CH2) to be 0° or 180°. The process of changing the compensation rotation angle to the rotation angle of the polarization may be performed using a known technique.

In the above-mentioned processing, the polarization management portion 236 fixes the rotation angle of the polarization of the first signal channel (CH1) from the reference angle, and performs control to change the rotation angle of the polarization of the second signal channel (CH2) from the reference angle by a compensation rotation angle. However, the polarization management portion 236 may fix the rotation angle of the polarization of the second signal channel (CH2) from the reference angle, and perform control to change the rotation angle of the polarization of the first signal channel (CH1) from the reference angle by a compensation rotation angle, and instruct the control device 100 to measure the reception characteristics (Q value) for each similar case, and process the case in which the reception characteristics are the best.

The polarization management portion 236 specifies the rotation angle of the polarization of the first signal channel (CH1) or the second signal channel (CH2) from the reference angle. This value is a value fixed by the process of matching the rotation angles from the reference angle of the polarization of the first signal channel (CH1) and the second signal channel (CH2) described above.

The polarization management portion 236 determines whether or not there is an unprocessed signal channel among the signal channels contained in the optical signal (step S907). If there is an unprocessed signal channel among the signal channels included in the optical signal (Yes in step S907), the polarization management portion 236 repeats the above-mentioned processing from step S901.

It is now assumed that an optical signal includes three channels: a first signal channel (CH1), a second signal channel (CH2), and a third signal channel (CH3). In this case, the polarization management portion 236 calculates a rotation angle φ1 from the reference angle of the polarization of the first signal channel (CH1) by the polarization monitor portion 234.

Similarly, for a third signal channel (CH3) indicating a frequency band adjacent to the second signal channel (CH2), the polarization management portion 236 calculates a detected rotation angle φ3 from the reference angle of the polarization of the third signal channel (CH3). Therefore, the polarization management portion 236 calculates candidate compensation rotation angles Δ (Δ3, Δ4 below) such that the difference between the actual rotation angle of the first signal channel (CH1) and the rotation angle of the third signal channel (CH3) is 0° or 180° (π).

That is, based on the rotation angle from the reference angle of polarization of a first signal channel among the multiple signal channels and the rotation angle from the reference angle of polarization of a third signal channel among the multiple signal channels, the polarization management portion 236 calculates the candidate compensation rotation angle Δ indicating the rotation angle from the reference angle of polarization of each signal channel in cases where this results in a difference in the rotation angle that improves the reception characteristics in the rear-stage device 41.

Accordingly, the polarization management portion 236 calculates the compensation rotation angle candidates Δ3 and Δ4 according to the following equations.

$$Δ 3 = φ 1 − φ 3$$

$$Δ 4 = φ 1 − φ 2 + 90 °$$

### (Case 3)

A compensation rotation angle Δ3 is calculated for the third signal channel (CH3). That is, a change of Δ3 is applied to the actual rotation angle of the polarization of the third signal channel (CH3) from the reference angle (an increase of Δ3).

### (Case 4)

A compensation rotation angle Δ4 is calculated for the third signal channel (CH3). That is, a change of Δ4 is applied to the actual rotation angle of the polarization of the third signal channel (CH3) from the reference angle (an increase of Δ4).

The network control portion 120 of the control device 100 compares the reception characteristic Q values of case 3 and case 4 to determine the optimal compensation rotation angle in the same manner as in step S902 described above.

### (Processing Assuming Case 3)

Assuming the above-mentioned case 3, the polarization management portion 236 outputs an implementation request to the polarization rotation calculation portion 235, which includes an identifier of the first signal channel (CH1), an identifier of the third signal channel (CH3), an identifier of the third signal channel whose polarization is to be rotated among those signal channels, and a compensation rotation angle Δ3. The polarization rotation calculation portion 235 adds the compensation rotation angle Δ3 to the polarization rotation angle of the third signal channel (CH3) based on the identifier of the third signal channel (CH3) whose polarization is to be rotated, which is included in the execution request. The polarization rotation calculation portion 235 outputs a measurement request for the reception characteristic value (Q value) in the rear-stage device 41 to the polarization management portion 236. The polarization management portion 236 outputs to the control device 100 a measurement request for a reception characteristic value (Q value) including the identifier of the first signal channel (CH1) and the identifier of the third signal channel (CH3). The rear-stage device 41 outputs the reception characteristic of each channel to the control device 100. Therefore, the network control portion 120 of the control device 100 receives the reception characteristics (Q value) of the first signal channel (CH1) and the third signal channel (CH3). The network control portion 120 of the control device 100 temporarily stores, in a state in which the compensation rotation angle Δ3 is added to the polarization rotation angle of the third signal channel (CH3), the third reception characteristic (Q value) of the first signal channel (CH1) and the third signal channel (CH3), the case number of case 3 (a number indicating processing assuming case 3), and the compensation rotation angle +Δ3 in association with each other.

### (Processing Assuming Case 4)

Assuming the above-mentioned case 4, the polarization management portion 236 outputs an implementation request to the polarization rotation calculation portion 235, which includes an identifier of the first signal channel (CH1), an identifier of the third signal channel (CH3), an identifier of the third signal channel whose polarization is to be rotated among those signal channels, and a compensation rotation angle Δ4. The polarization rotation calculation portion 235 adds the compensation rotation angle Δ4 to the polarization rotation angle of the third signal channel (CH3) based on the identifier of the third signal channel (CH3) whose polarization is to be rotated, which is included in the execution request. The polarization rotation calculation portion 235 outputs a measurement request for the reception characteristic value (Q value) in the rear-stage device 41 to the polarization management portion 236. The polarization management portion 236 outputs to the control device 100 a measurement request for a reception characteristic value (Q value) including the identifier of the first signal channel (CH1) and the identifier of the third signal channel (CH3). The rear-stage device 41 outputs the reception characteristic of each channel to the control device 100. Therefore, the network control portion 120 of the control device 100 receives the reception characteristics (Q value) of the first signal channel (CH1) and the third signal channel (CH3). The network control portion 120 of the control device 100 temporarily stores, in a state in which the compensation rotation angle Δ4 is added to the polarization rotation angle of the third signal channel (CH3), the fourth reception characteristic (Q value) of the first signal channel (CH1) and the third signal channel (CH3), the case number of case 4 (a number indicating processing assuming case 4), and the compensation rotation angle +Δ4 in association with each other.

That is, in the processing assuming case 3 and the processing assuming case 4, the network control portion 120 of the control device 100 calculates candidates for control values including a compensation rotation angle Δ indicating the rotation angle from the reference angle of the polarization of each signal channel in cases where this results in a difference in rotation angle that improves the reception characteristics in the rear-stage device 41 (step S903). For example, in the case of processing assuming case 3, the compensation rotation angle of the first signal channel is 0, and the compensation rotation angle of the third signal channel is +Δ3. In the case of processing assuming case 4, the compensation rotation angle of the first signal channel is 0, and the compensation rotation angle of the third signal channel is +Δ4.

The polarization management portion 236 detects the completion of transmission of measurement requests for all cases, case 3 to case 4, which are assumed cases for determining whether the reception characteristics will improve by adding a compensation rotation angle change to the rotation angle of the polarization of the third signal channel (CH3) without moving the polarization of the first signal channel (CH1) and the second signal channel (CH2). The polarization management portion 236 outputs the completion of the measurement request transmission to the control device 100.

The network control portion 120 of the control device 100 identifies the case number having the highest Q value among the Q values indicated by the stored third and fourth reception characteristics. That is, in this process, the network control portion 120 of the control device 100 identifies a control value including a compensation rotation angle Δ indicating the rotation angle of the polarization of the signal channel from the reference angle in a case where the Q value indicated by the reception characteristics is the highest Q value (step S904).

The control device 100 transmits a control value including the identified case number and the compensation rotation angle for that case number to the optical repeater 200 (step S905). The polarization rotation calculation portion 235 of the optical repeater 200 uses the case number and the compensation rotation angle for that case number to align the rotation angles from the reference angle of the polarization of the first signal channel (CH1), the second signal channel (CH2), and the third signal channel (CH3) (step S906). Since the rotation angles of the polarization of the first signal channel (CH1) and the second signal channel (CH2) from the reference angle are already the same, it is only necessary to match the rotation angle of the polarization of the third signal channel (CH3) from the reference angle to these rotation angles. For example, it is assumed that the control value includes the case number of case 3 (a number indicating processing assuming case 3) and a compensation rotation angle Δ3. In this case, the polarization rotation calculation portion 235 adds the compensation rotation angle Δ3 to the polarization rotation angle of the third signal channel (CH3) to control and fix the difference between the rotation angle from the reference angle of the polarization of the first signal channel (CH1) (or the rotation angle from the reference angle of the polarization of the second signal channel (CH2)) and the rotation angle from the reference angle of the polarization of the third signal channel (CH3) to be 0° or 180°. The process of adding a change of the compensation rotation angle to the rotation angle of the polarization may be performed using a known technique.

The polarization management portion 236 determines whether or not there is an unprocessed signal channel among the signal channels contained in the optical signal (step S907). If there is no signal channel that has not been processed among the signal channels included in the optical signal (No in step S907), the polarization management portion 236 ends the process.

In the above-mentioned processing, the polarization management portion 236 fixes the rotation angle of the polarization of the first signal channel (CH1) from the reference angle, and performs control to change the rotation angle of the polarization of the third signal channel (CH3) from the reference angle by a compensation rotation angle. However, the polarization management portion 236 may fix the rotation angle of the polarization of the third signal channel (CH3) from the reference angle, and perform control to change the rotation angle of the polarization of the first signal channel (CH1) and the second signal channel (CH2) from the reference angle by a compensation rotation angle, and instruct the control device 100 to measure the reception characteristics (Q value) for each similar case, and process the case in which the reception characteristics are the best.

By the above processing, in a case where the optical signal includes the first signal channel (CH1), the second signal channel (CH2), and the third signal channel (CH3), the difference in the rotation angle from the reference angle of the polarization of each signal channel becomes 0° or 180°, thereby improving the reception characteristics in the rear-stage device 41. Even in a case where the optical signal contains four or more signal channels, the optical repeater 200, the rear-stage device 41, and the control device 100 work together to achieve a similar effect by setting the difference in rotation angle from the reference angle of polarization of each signal channel to 0° or 180°.

The above-mentioned processing of the optical repeater 200 is an example of processing that, based on the rotation angle from the reference angle of polarization of the first signal channel among the multiple signal channels and the rotation angle from the reference angle of polarization of the second signal channel among the multiple signal channels, acquires a control value including the rotation angle from the reference angle of polarization of each signal channel in cases where this results in a difference in the rotation angle that improves the reception characteristics in the rear-stage device 41, and aligns the rotation angle of the first signal channel from the reference angle of polarization and the rotation angle of the second signal channel from the reference angle based on the rotation angles of each signal channel.

Furthermore, the processing of the optical repeater 200 described above is an example of processing of sequentially acquiring the control value in a case where a combination of the first signal channel selected from the plurality of signal channels and the second signal channel selected from the plurality of signal channels is changed each time the combination is changed, and repeating the process of aligning the rotation angle from the reference angle of polarization of one of the first signal channel or the second signal channel to the rotation angle from the reference angle of the polarization of the other based on each of the control values to match the rotation angles from the reference angle of the polarization of all of the multiple signal channels.

FIG. 20 is a functional block diagram of an optical repeater according to another example.

FIG. 21 is a diagram showing a process flow of the optical repeater according to another example.

The optical repeater 200 may include a polarization monitor portion 234 (monitoring means) and a polarization rotation calculation portion 235 (calculating means).

The polarization monitor portion 234 monitors the rotation angle from a reference angle of the polarization indicated by a plurality of signal channels included in the optical signal (Step S2001).

The polarization rotation calculation portion 235 using a control value that controls the rotation angle from a reference angle of polarization of any one of the plurality of signal channels to align the rotation angle from a reference angle of polarization of each signal channel to a rotation angle that improves the reception characteristics of each signal channel (Step S2002).

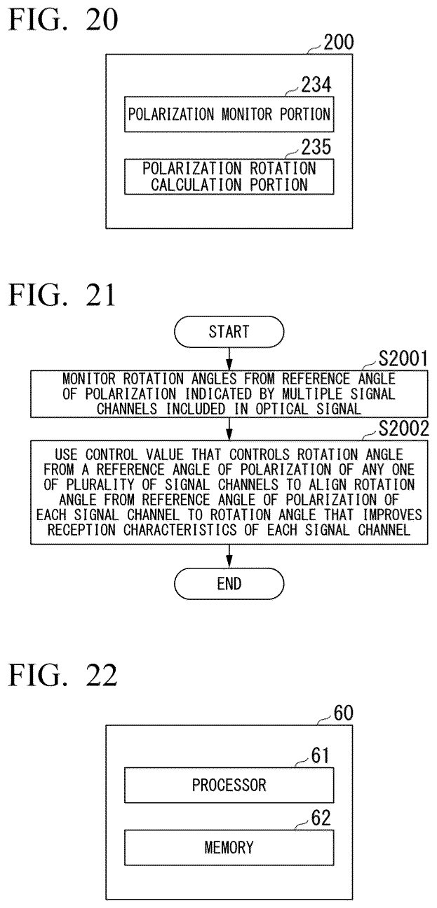

The control device, optical repeater, transmitting end station device, and receiving end station device in the above-mentioned example embodiments may be constituted by hardware or software, or both, and may be constituted by a single piece of hardware or software, or may be constituted by multiple pieces of hardware or software. Each device (control device, or the like) and each function (processing) may be realized by a computer 60 having a processor 61 such as a CPU (central processing unit) and a memory 62 serving as a storage device, as shown in FIG. 22. For example, a program for carrying out a method (such as a control method) in the example embodiment may be stored in the memory 62, and each function may be realized by executing the program stored in the memory 62 by the processor 61.

These programs include a set of instructions (or software code) that, in a case where loaded into a computer, cause the computer to perform one or more functions described in the example embodiments. The program may be stored in a non-transitory computer-readable medium or a tangible storage medium. By way of example and not limitation, a computer-readable medium or tangible storage medium includes random-access memory (RAM), read-only memory (ROM), flash memory, a solid-state drive (SSD) or other memory technology, a CD-ROM, a digital versatile disc (DVD), a Blu-ray (registered trademark) discs or other optical disc storage, magnetic cassettes, magnetic tape, magnetic disk storage, or other magnetic storage devices. The program may be transmitted on a transitory computer-readable medium or a communication medium. By way of example, and not limitation, transitory computer-readable media or communication media include electrical, optical, acoustic, or other forms of propagated signals.

Although the control device 100, the optical repeater 200, the transmitting end station device 30, and the receiving end station device 40 of this disclosure have been described above, this disclosure is not limited to the above-mentioned example embodiments.

According to the above example embodiment, it is possible to suppress degradation of signal quality in optical transmission.

While preferred example embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

Note that some or all of the above-described example embodiments can be described as, but are not limited to, the following supplementary notes.

### (Supplementary Note 1)

An optical repeater comprising:
a monitor means that monitors a rotation angle from a reference angle of polarization indicated by a plurality of signal channels included in an optical signal; and
a calculation means that uses a control value that controls the rotation angle from the reference angle of polarization of any of the plurality of signal channels to align the rotation angle from a reference angle of polarization of each signal channel to a rotation angle that improves the reception characteristics of each signal channel.

### (Supplementary Note 2)

The optical repeater according to Supplementary Note 1,
wherein the calculation means, based on the rotation angle from the reference angle of polarization of a first signal channel among the plurality of signal channels and the rotation angle from the reference angle of polarization of a second signal channel among the plurality of signal channels, acquires the control value including the rotation angle from the reference angle of polarization of each signal channel in cases where this results in a difference in the rotation angle that improves the reception characteristics in a rear-stage device, and aligns the rotation angle from the reference angle of polarization of the first signal channel and the rotation angle from the reference angle of polarization of the second signal channel based on the rotation angles of each signal channel.

### (Supplementary Note 3)

The optical repeater according to Supplementary Note 2,
wherein the calculation means sequentially acquires the control value in a case where a combination of the first signal channel selected from the plurality of signal channels and the second signal channel selected from the plurality of signal channels is changed each time the combination is changed, and repeats the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

### (Supplementary Note 4)

The optical repeater according to Supplementary Note 3,
wherein the calculation means acquires from the control device the control value including a rotation angle from a reference angle of polarization of each signal channel calculated by the control device based on the reception characteristics of each of the plurality of signal channels received from the rear-stage device, and including the rotation angle from the reference angle of polarization of each signal channel in cases where this results in a difference in the rotation angle that improves the reception characteristics in the rear-stage device.

### (Supplementary Note 5)

The optical repeater according to any one of Supplementary Note 2 to Supplementary Note 4,
wherein the calculation means acquires the control value that includes the rotation angle from the reference angle of polarization of each signal channel in cases where this results in a difference in the rotation angle that improves the reception characteristics in the rear-stage device, such that the difference between the rotation angle from the reference angle of polarization of a first signal channel among the plurality of signal channels and the rotation angle from the reference angle of polarization of a second signal channel among the plurality of signal channels is 0 or 7π.

### (Supplementary Note 6)

An optical network system comprising:
an optical repeater and a control device,
wherein the optical repeater comprises:
a monitor means that monitors a rotation angle from a reference angle of polarization indicated by a plurality of signal channels included in an optical signal; and
a calculation means that uses a control value that controls the rotation angle from the reference angle of polarization of any of the plurality of signal channels to align the rotation angle from a reference angle of polarization of each signal channel to a rotation angle that improves the reception characteristics of each signal channel.
and the control device comprises:
a management means that calculates the control value based on the reception characteristic of the optical signal in a rear-stage device that received the optical signal relayed by the optical repeater, and outputs the control value to the optical repeater.

### (Supplementary Note 7)

The optical network system according to Supplementary Note 6,
wherein the calculation means, based on the rotation angle from the reference angle of polarization of a first signal channel among the plurality of signal channels and the rotation angle from the reference angle of polarization of a second signal channel among the plurality of signal channels, acquires the control value including the rotation angle from the reference angle of polarization of each signal channel in cases where this results in a difference in the rotation angle that improves the reception characteristics in a rear-stage device, and aligns the rotation angle from the reference angle of polarization of the first signal channel and the rotation angle from the reference angle of polarization of the second signal channel based on the rotation angles of each signal channel.

### (Supplementary Note 8)

The optical network system according to Supplementary Note 7,
wherein the calculation means sequentially acquires the control value in a case where a combination of the first signal channel selected from the plurality of signal channels and the second signal channel selected from the plurality of signal channels is changed each time the combination is changed, and repeats the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

### (Supplementary Note 9)

The optical network system according to any one of Supplementary Note 6 to Supplementary Note 8,
wherein the management means of the control device
generates the control value including a rotation angle from a reference angle of polarization of each signal channel calculated by the control device based on the reception characteristics of each of the plurality of signal channels received from the rear-stage device, and including the rotation angle from the reference angle of polarization of each signal channel in cases where this results in a difference in the rotation angle that improves the reception characteristics in the rear-stage device.

### (Supplementary Note 10)

The optical network system according to any one of Supplementary Note 7 to Supplementary Note 9,
wherein the management means generates the control value that includes the rotation angle from the reference angle of polarization of each signal channel in cases where this results in a difference in the rotation angle that improves the reception characteristics in the rear-stage device, such that the difference between the rotation angle from the reference angle of polarization of a first signal channel among the plurality of signal channels and the rotation angle from the reference angle of polarization of a second signal channel among the plurality of signal channels is 0 or 7π.

### (Supplementary Note 11)

An optical repeating method that
monitors a rotation angle from a reference angle of polarization indicated by a plurality of signal channels included in an optical signal; and
uses a control value that controls the rotation angle from the reference angle of polarization of any of the plurality of signal channels to align the rotation angle from a reference angle of polarization of each signal channel to a rotation angle that improves the reception characteristics of each signal channel.

### (Supplementary Note 12)

The optical repeating method according to Supplementary Note 11,
based on the rotation angle from the reference angle of polarization of a first signal channel among the plurality of signal channels and the rotation angle from the reference angle of polarization of a second signal channel among the plurality of signal channels, acquiring the control value including the rotation angle from the reference angle of polarization of each signal channel in cases where this results in a difference in the rotation angle that improves the reception characteristics in a rear-stage device, and aligning the rotation angle from the reference angle of polarization of the first signal channel and the rotation angle from the reference angle of polarization of the second signal channel based on the rotation angles of each signal channel.

### (Supplementary Note 13)

The optical repeating method according to Supplementary Note 12,
sequentially acquiring the control value in a case where a combination of the first signal channel selected from the plurality of signal channels and the second signal channel selected from the plurality of signal channels is changed each time the combination is changed, and repeating the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

### (Supplementary Note 14)

The optical repeating method according to Supplementary Note 13,
acquiring from the control device the control value including a rotation angle from a reference angle of polarization of each signal channel calculated by the control device based on the reception characteristics of each of the plurality of signal channels received from the rear-stage device, and including the rotation angle from the reference angle of polarization of each signal channel in cases where this results in a difference in the rotation angle that improves the reception characteristics in the rear-stage device.

### (Supplementary Note 15)

The optical repeating method according to any one of Supplementary Note 12 to Supplementary Note 14,
acquiring the control value that includes the rotation angle from the reference angle of polarization of each signal channel in cases where this results in a difference in the rotation angle that improves the reception characteristics in the rear-stage device, such that the difference between the rotation angle from the reference angle of polarization of a first signal channel among the plurality of signal channels and the rotation angle from the reference angle of polarization of a second signal channel among the plurality of signal channels is 0 or 7π.

### (Supplementary Note 16)

A program that causes a computer of an optical repeater to function as
a monitor means that monitors a rotation angle from a reference angle of polarization indicated by a plurality of signal channels included in an optical signal; and
a calculation means that uses a control value that controls the rotation angle from the reference angle of polarization of any of the plurality of signal channels to align the rotation angle from a reference angle of polarization of each signal channel to a rotation angle that improves the reception characteristics of each signal channel.

### (Supplementary Note 17)

The program according to Supplementary Note 16,
wherein the calculation means, based on the rotation angle from the reference angle of polarization of a first signal channel among the plurality of signal channels and the rotation angle from the reference angle of polarization of a second signal channel among the plurality of signal channels, acquires the control value including the rotation angle from the reference angle of polarization of each signal channel in cases where this results in a difference in the rotation angle that improves the reception characteristics in a rear-stage device, and aligns the rotation angle from the reference angle of polarization of the first signal channel and the rotation angle from the reference angle of polarization of the second signal channel based on the rotation angles of each signal channel.

### (Supplementary Note 18)

The program according to Supplementary Note 17,
wherein the calculation means sequentially acquires the control value in a case where a combination of the first signal channel selected from the plurality of signal channels and the second signal channel selected from the plurality of signal channels is changed each time the combination is changed, and repeats the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

### (Supplementary Note 19)

The program according to Supplementary Note 18,
wherein the calculation means acquires from the control device the control value including a rotation angle from a reference angle of polarization of each signal channel calculated by the control device based on the reception characteristics of each of the plurality of signal channels received from the rear-stage device, and including the rotation angle from the reference angle of polarization of each signal channel in cases where this results in a difference in the rotation angle that improves the reception characteristics in the rear-stage device.

### (Supplementary Note 20)

The program according to any one of Supplementary Note 17 to Supplementary Note 19,
wherein the calculation means acquires the control value that includes the rotation angle from the reference angle of polarization of each signal channel in cases where this results in a difference in the rotation angle that improves the reception characteristics in the rear-stage device, such that the difference between the rotation angle from the reference angle of polarization of a first signal channel among the plurality of signal channels and the rotation angle from the reference angle of polarization of a second signal channel among the plurality of signal channels is 0 or 7π.

What is claimed is:

1. An optical repeater comprising:
at least one memory configured to store instructions; and
at least one processor configured to execute the instructions to:
monitor a rotation angle from a reference angle of polarization indicated by a plurality of signal channels included in an optical signal; and
use a control value that controls the rotation angle from the reference angle of polarization of any of the plurality of signal channels to align the rotation angle from a reference angle of polarization of each signal channel to a rotation angle that improves the reception characteristics of each signal channel.

2. The optical repeater according to claim 1, wherein the at least one processor is configured to execute the instructions to:
acquire, based on the rotation angle from the reference angle of polarization of a first signal channel among the plurality of signal channels and the rotation angle from the reference angle of polarization of a second signal channel among the plurality of signal channels, acquires the control value including the rotation angle from the reference angle of polarization of each signal channel so that a difference in the rotation angle improves the reception characteristics in a rear-stage device; and
align the rotation angle from the reference angle of polarization of the first signal channel and the rotation angle from the reference angle of polarization of the second signal channel based on the rotation angles of each signal channel.

3. The optical repeater according to claim 2, wherein the at least one processor is configured to execute the instructions to:
sequentially acquire the control value in a case where a combination of the first signal channel selected from the plurality of signal channels and the second signal channel selected from the plurality of signal channels is changed each time the combination is changed; and
repeat the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

4. The optical repeater according to claim 3, wherein the at least one processor is configured to execute the instructions to acquire from the control device the control value including a rotation angle from a reference angle of polarization of each signal channel calculated by the control device based on the reception characteristics of each of the plurality of signal channels received from the rear-stage device, and including the rotation angle from the reference angle of polarization of each signal channel so that a difference in the rotation angle improves the reception characteristics in the rear-stage device.

5. An optical network system comprising:
an optical repeater and a controller,
wherein the optical repeater comprises:
at least one first memory configured to store first instructions; and
at least one first processor configured to execute the first instructions to:
monitor a rotation angle from a reference angle of polarization indicated by a plurality of signal channels included in an optical signal; and
use a control value that controls the rotation angle from the reference angle of polarization of any of the plurality of signal channels to align the rotation angle from a reference angle of polarization of each signal channel to a rotation angle that improves the reception characteristics of each signal channel,
and the controller comprises:
at least one second memory configured to store second instructions; and
at least one second processor configured to execute the second instructions to:
calculate the control value based on the reception characteristic of the optical signal in a rear-stage device that received the optical signal relayed by the optical repeater; and
output the control value to the optical repeater.

6. The optical network system according to claim 5, wherein the at least one first processor is configured to execute the instructions to:
based on the rotation angle from the reference angle of polarization of a first signal channel among the plurality of signal channels and the rotation angle from the reference angle of polarization of a second signal channel among the plurality of signal channels, acquire the control value including the rotation angle from the reference angle of polarization of each signal channel so that a difference in the rotation angle improves the reception characteristics in a rear-stage device; and
align the rotation angle from the reference angle of polarization of the first signal channel and the rotation angle from the reference angle of polarization of the second signal channel based on the rotation angles of each signal channel.

7. The optical network system according to claim 6, wherein the at least one first processor is configured to execute the instructions to
sequentially acquire the control value in a case where a combination of the first signal channel selected from the plurality of signal channels and the second signal channel selected from the plurality of signal channels is changed each time the combination is changed; and
repeat the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

8. The optical network system according to claim 5, wherein the at least one second processor is configured to execute the instructions to generate the control value including a rotation angle from a reference angle of polarization of each signal channel calculated by the controller based on the reception characteristics of each of the plurality of signal channels received from the rear-stage device, and including the rotation angle from the reference angle of polarization of each signal channel so that a difference in the rotation angle improves the reception characteristics in the rear-stage device.

9. An optical repeating method comprising:
monitoring a rotation angle from a reference angle of polarization indicated by a plurality of signal channels included in an optical signal; and
using a control value that controls the rotation angle from the reference angle of polarization of any of the plurality of signal channels to align the rotation angle from a reference angle of polarization of each signal channel to a rotation angle that improves the reception characteristics of each signal channel.

10. The optical repeating method according to claim 9, further comprising:
acquiring, based on the rotation angle from the reference angle of polarization of a first signal channel among the plurality of signal channels and the rotation angle from the reference angle of polarization of a second signal channel among the plurality of signal channels, acquires the control value including the rotation angle from the reference angle of polarization of each signal channel so that a difference in the rotation angle improves the reception characteristics in a rear-stage device; and
aligning the rotation angle from the reference angle of polarization of the first signal channel and the rotation angle from the reference angle of polarization of the second signal channel based on the rotation angles of each signal channel.

11. The optical repeating method according to claim 10, further comprising:
sequentially acquiring the control value in a case where a combination of the first signal channel selected from the plurality of signal channels and the second signal channel selected from the plurality of signal channels is changed each time the combination is changed; and
repeating the process of aligning the rotation angle from the reference angle of polarization of one of the first signal channel or the second signal channel to the rotation angle from the reference angle of the polarization of the other based on each of the control values to match the rotation angles from the reference angle of the polarization of all of the plurality of signal channels.

12. The optical repeating method according to claim 11, further comprising acquiring from the control device the control value including a rotation angle from a reference angle of polarization of each signal channel calculated by the control device based on the reception characteristics of each of the plurality of signal channels received from the rear-stage device, and including the rotation angle from the reference angle of polarization of each signal channel so that a difference in the rotation angle improves the reception characteristics in the rear-stage device.
